(19) United States
(12) Patent Application Publication
(10) Pub. No.: US 2004/0083258 A1
(43) Pub. Date: Apr. 29, 2004

(54) Information processing method and apparatus, recording medium, and program

(76) Inventors: Naoya Haneda, Tokyo (JP); Kyoya Tsutsui, Kanagawa (JP); Kenzo Akagiri, Kanagawa (JP)

Correspondence Address: FROMMER LAWRENCE & HAUG LLP, 745 FIFTH AVENUE, NEW YORK, NY, 10151, US

(21) Appl. No.: 10/651,580

(22) Filed: Aug. 29, 2003

(30) Foreign Application Priority Data
Aug. 30, 2002 (JP) P2002-253356

(51) Int. Cl. G06F 15/16

(52) U.S. Cl. 709/201

(57) ABSTRACT

Upon receiving a request to send responding additional data, an additional-data transmitting device generates responding additional data and sends it to the requestor. The header of the responding additional data contains a content ID and the number of sample zones. At the head of additional frames in each online sample zone, the sample-data start position and the sample zone length are indicated. Upon receiving the responding additional data, the requestor generates sample playback data by using sample data and the responding additional data. In the sample playback data, frames which are reconstructed into higher-quality data than the responding additional data are indicated in sample zones. In other zones, sample frames are contained. The invention can be applied to a coding device, an additional-data transmitting device, a data playback device, and a data recording device.

### BACKGROUND OF THE INVENTION

1. Field of the Invention

The present invention relates to information processing methods and apparatuses, recording media, and programs. More particularly, the invention relates to an information processing method and apparatus, a recording medium, and a program, which are suitable for distributing sample data (trial data) of content to users.

2. Description of the Related Art

Due to widespread use of communication network technologies including the Internet, improvements in information compression techniques, and enhanced integration or density of information recording media, pay distribution of digital content including various multimedia data, such as audio, still images, moving pictures, and a combination of audio and moving pictures, for example, movies, to users are conducted via communication networks.

A store that sells package media, such as compact disks (CDs) or mini-disks (MDs) (trademark), that is, recording media in which digital content is recorded, is installed with an information terminal, a so-called multimedia kiosk (MMK), in which many pieces of digital content including music data are stored. This enables the store not only to sell package media, but also to sell digital content.

A user brings a recording medium, such as an MD, and inserts it into the MMK. The user then selects the title of digital content to be purchased by referring to a menu screen, and pays for the content. Payment may be made by cash, electronic money, or electronic settlement by a credit card or a prepaid card. The MMK records the selected digital content data on the recording medium inserted by the user by performing predetermined processing.

As described above, digital content sellers can sell digital content by using the MMK, and can also distribute digital content to users via, for example, the Internet.

Content can be distributed more effectively not only by selling package media having content recorded thereon, but also by selling digital content itself.

In order to distribute digital content while protecting the copyright, techniques, for example, those disclosed in Japanese Unexamined Patent Application Publication Nos. 2001-103047 and 2001-325460 can be used. Portions of digital content other than portions that are permitted to preview or listen to on a trial basis are encrypted, and the digital content is distributed. Then, only users who have purchased a decryption key for the corresponding encryption are permitted to preview or listen to the entire content. As a known encryption method, the initial value of a random number sequence is given to a bit string of a pulse code modulation (PCM) digital audio signal as a key signal, and a bit string obtained by performing an exclusive-OR of the generated 0/1 random number sequence and the above-described PCM bit string is used as an encrypted bit stream. The digital content encrypted as described above is recorded on a recording medium by using, for example, the above-described MMK, or is transmitted via a network to be distributed to a user. Unless the user who has obtained the digital content data has a key, the user is only permitted to preview or listen to an unencrypted portion. If the encrypted portion is played back without being decrypted, only noise is heard.

There have been improvements in techniques for compressing audio data and broadcasting it, distributing audio data via a network, and recording compressed data on various recording media, such as magneto-optical disks.

There are various techniques for coding audio signals with high efficiency. For example, in a block-less frequency-band division technique, i.e., a so-called “sub-band coding (SBC)”, an audio signal in the time domain is divided into a plurality of frequency bands and coded without dividing them into blocks. In a block frequency-band division technique, i.e., a so-called “transform coding”, a signal in the time domain is transformed (spectrum transform) into a signal in the frequency domain so as to be divided into a plurality of frequency bands. The signal components are then coded in each band. Another high-efficiency coding technique, which is a combination of the above-described sub-band coding and transform coding, has also been considered. In this case, for example, after sub-band division is performed in the above-described SBC, signal components in each sub band are transformed into signal components in the frequency domain, and are then coded in each band.

Filters used in the above-described high-efficiency coding methods include quadrature mirror filters (QMF), details of which are described in R. E. Crochiere, “Digital Coding of Speech in Subbands” (Bell Syst. Tech. J., vol. 55, No. 8, 1974). An equal-bandwidth filtering technique is described in Joseph H. Rothweiler, “Polyphase Quadrature Filters—a New Subband Coding Technique” (ICASSP 83, BOSTON).

As the above-described spectrum transform, for example, an input audio signal is formed into blocks in predetermined time units (frames), and discrete Fourier transform (DFT), discrete cosine transform (DCT), or modified DCT (MDCT) is performed on the signal components in each block, thereby transforming a time-domain signal into a frequency-domain signal. Details of MDCT are described in J. P. Princen and A. B. Bradley, (Univ. of Surrey, Royal Melbourne Inst. of Tech.), “Subband/Transform Coding Using Filter Bank Designs Based on Time Domain Aliasing Cancellation” (ICASSP 1987).

In the spectrum transform using the above-described DFT or DCT, when the spectrum transform is performed in a time block consisting of M samples, M items of independent real-number data are obtained. Generally, in order to reduce distortion at the connections between time blocks, one block overlaps with each of the adjacent blocks by N/2 samples, and thus, a total of N samples are overlapped with the two adjacent blocks. On average, in DFT or DCT, M items of real-number data are quantized and coded for (M+N) samples.

In contrast, in the spectrum transform using the above-described MDCT, when the spectrum transform is performed in a time block consisting of M samples, M items of real-number data is obtained. One block overlaps with each of the adjacent blocks by M/2 samples, and thus, a total of M samples are overlapped with the two adjacent blocks. Accordingly, in MDCT, M items of real-number data are obtained from 2M samples. On average, in MDCT, M items of real-number data are quantized and coded for M samples.

In a decoding apparatus, coded data obtained by performing MDCT is inverse-transformed in each block, and the resulting waveform components are added together while interfering with each other so as to reconstruct a waveform signal.

Generally, the spectrum frequency resolution is enhanced as the time block for spectrum transform becomes longer, thereby allowing energy to be concentrated in specific spectral components. As described above, in MDCT, the spectrum transform is performed with an increased block length by overlapping samples between adjacent blocks, and the number of spectral signal components remains the same as the original number of samples. By using such MDCT, coding can be performed with higher efficiency than by using DFT or DCT. Also, by allowing a sufficiently long overlapping portion between adjacent blocks, inter-block distortion of the waveform signal can be reduced.

By quantizing signal components divided into sub bands by using a filter or spectrum transform, bands in which quantizing noise is generated can be controlled, and high-efficiency coding can be performed by utilizing the masking effect. Before performing quantizing, if signal components in each band are normalized by the maximum of the absolute values of the signal components in the corresponding band, higher efficiency coding can be performed.

When quantizing signal components divided into frequency bands, the bandwidths may be determined by considering, for example, human acoustic characteristics. That is, generally, an audio signal may be divided into a plurality of bands (for example, 25 bands) so that the bandwidth of the higher bands, which are referred to as the “critical bands”, becomes greater.

When the bandwidths are determined so that the bandwidth of critical bands becomes greater, data in each band is coded according to a predetermined bit distribution or an adaptive bit allocation.

It is now assumed, for example, that coefficient data obtained by the above-described MDCT processing is coded by an adaptive bit allocation. In this case, the number of bits are adaptively allocated to MDCT coefficient data in each band, and the MDCT coefficient data is then coded. The following two bit allocation techniques are known.

One technique is disclosed in R. Zelinski and P. Noll, “Adaptive Transform Coding of Speech Signals” (IEEE Transactions of Acoustics, Speech, and Signal Processing, Vol. ASSP-25, No. 4, August 1977). In this technique, bit allocation is performed according to the magnitude of the signal in each band, and thus, the quantizing noise spectrum becomes flat to minimize the noise energy. However, since the masking effect is not employed, the actual sound is not acoustically optimal for reducing noise.

The other technique is disclosed in M. A. Kransner (Massachusetts Institute of Technology), “The Critical Band Coder—Digital Encoding of the Perceptual Requirements of the Auditory System” (ICASSP 1980). In this method, by utilizing the masking effect, fixed bit allocation is performed for determining a signal-to-noise (S/N) ratio required for each band. However, due to the fixed bit allocation, even when the characteristic of a sinusoidal wave input is measured, a precise value cannot be obtained.

In order to overcome the above drawbacks, the following high-efficiency coding apparatus has been proposed. All the bits available to bit allocation are divided into bits for fixed bit allocation and bits for adaptive bit allocation. The division ratio of the two types of bit allocations is determined by an input signal, and the division ratio of the fixed bit allocation becomes higher as the signal spectrum becomes smoother.

According to the above-described coding apparatus, many bits can be allocated to blocks containing specific spectral components, such as sinusoidal waves, in which energy is concentrated, thereby making it possible to considerably improve the overall S/N ratio characteristics. Generally, the human acoustic characteristics are extremely sensitive to signals having sharp spectral components. Accordingly, an improved S/N ratio by using this method is effective not only in enhancing precise measurements, but also in improving the sound quality.

Many other bit allocation techniques have been proposed. Because of increasingly precise acoustic models and higher performance of coding apparatuses, even higher efficiency coding is possible not only in terms of measured values, but also for human acoustic characteristics. In these methods, the bit-allocation real-number reference value is determined so that the calculated S/N ratio can be achieved as faithfully as possible, and the integer approximating the reference value is used as the number of allocation bits.

In Japanese Patent Application No. 5-152865 or WO94/28633 filed by the present inventors, another coding method has been proposed in which tone components that are particularly important in an acoustic sense, i.e., signal components in which energy is concentrated, are extracted from a spectrum signal, and are separately coded from the other spectral components. According to this coding method, audio signals can be efficiently coded with a high compression ratio with very little degradation.

In forming code strings, quantizing-precision information and normalizing-coefficient information are first coded with a predetermined number of bits in each band, and the resulting normalized and quantized spectrum signal is coded. A high-efficiency coding method in which the number of bits representing the quantizing precision differs according to the band is described in ISO/IEC 11172-3: 1993(E), a933. In this standard, the number of bits indicating the quantizing-precision information becomes smaller as the band becomes higher.

Instead of directly coding quantizing precision information, the quantizing-precision information may be determined from the normalizing-coefficient information in a decoding apparatus. According to this method, however, the relationship between the normalizing-coefficient information and the quantizing-precision information is determined when the standard is set, which makes it impossible to introduce the quantizing precision based on more precise acoustic models in the future. Additionally, if the compression ratio has a range, the relationship between the normalizing-coefficient information and the quantizing-precision information has to be determined according to each range.

Another known coding method is disclosed in D. A. Huffman, “A Method for Construction of Minimum Redundancy Codes” (Proc. I.R.E., 40, p. 1098, 1952). In this method, a quantized spectrum signal is coded more efficiently by using variable codes.

The signal coded as described above can be encrypted and distributed, as in PCM signals, in which case, those who have not obtained the corresponding key are unable to play back the original signal. Alternatively, instead of encrypting a coded bit string, a PCM signal may be converted into a random signal, which is then coded for compression. It is also impossible for users who have not obtained the corresponding key to play back the original signal, and only noise is heard.

Distribution of sample data (trial data) of content data promotes sales of the content data. The sample data includes data to be played back with lower quality than the original data and data for playing back part of the original data (for example, only refrains of an original piece of music). A user plays back the sample data, and if the user likes it, the user purchases a key for decrypting the encrypted data to play back the original sound. Alternatively, the user downloads original audio data or purchases a recording medium in which the original audio data is recorded.

In the above-described content protection methods, however, the entire data cannot be played back, or only noise is heard. Accordingly, these methods cannot be used for, for example, distributing recording media storing audio data recorded with a relatively low audio quality as sample data. Even if data scrambled by one of the above-described methods is distributed to a user, the user is unable to understand the overall content of the data.

When encrypting signals subjected to high-efficiency coding, it is very. difficult to maintain the compression efficiency while providing code strings that are meaningful for regular playback means. That is, when a code string generated by performing high-efficiency coding is scrambled and is then played back, as described above, only noise is heard, and also, playback means may not operate at all if the scrambled code string is not compatible with the original high-efficiency code standard.

Also, when a scrambled PCM signal is coded with high efficiency and the amount of information is reduced by utilizing the acoustic characteristics, coding becomes irreversible. Accordingly, the scrambled PCM signal cannot be correctly reconstructed when the coded signal is decoded. Thus, it is very difficult to descramble the signal.

Therefore, a method for precisely descrambling the signal must be employed by sacrificing the compression efficiency.

Japanese Unexamined Patent Application Publication No. 10-135944 filed by the present inventors discloses the following audio coding method. In this method, among spectral signal components coded from a music signal, signal components only in higher bands are encrypted and are distributed as sample data, thereby enabling users to play back unencrypted signal components in a narrow band without a corresponding key. In this method, signal components only in higher bands are encrypted, and also, high-band bit allocation information is replaced by dummy data, true bit allocation information being recorded at a position ignored by playback decoders.

According to this method, a user receives the distributed sample data, plays it back, and then purchases a key for decrypting the sample data that the user likes into the original data. The user is then able to play back a desired piece of music correctly in all the bands and enjoy the music with high sound quality.

However, instead of distributing sample data in which the entire content can be previewed or listened to although the quality is restricted according to the above-described known methods, some content providers desire to distribute sample data in which only part of the content can be previewed or listened to in order to enhance highly secure protection of the copyright of the content.

Accordingly, if a content distributor desires, when distributing sample data free of charge, that only tens of seconds of a music piece be played back to allow a user to listen to, the distributor must prohibit the other portions of the music piece from being played back by the user. Accordingly, the user has to determine whether the user likes to purchase the entire content after listening to only a short period of portion of the music piece. That is, such sample data is not sufficient for making users desire to purchase the music piece.

### SUMMARY OF THE INVENTION

Accordingly, in view of the above-described background, it is an object of the present invention to distribute, in distributing sample data of content data, additional data for allowing a user to preview or listen to unfixed portions in response to a request from the user to send the sample data, and to distribute additional data for allowing the user to play back or record original data in response to a request from the user to send the original data, so that the sample data and the original data can be distributed while maintaining the security of the sample data.

In order to achieve the above-described object, according to one aspect of the present invention, there is provided an information processing method including: an acquisition control step of controlling the acquisition of a fifth data string containing first data required for reconstructing a second data string into a first data string; a zone determining step of determining at least one zone of a fourth data string to be played back or recorded by a first information processing apparatus; and a first generating step of generating a third data string to be distributed to the first information processing apparatus from the fifth data string controlled to be acquired in the acquisition control step based on at least one zone determined in the zone determining step.

In the zone determining step, a plurality of data zone candidates may be prepared, and at least one of the data zone candidates may be selected from the plurality of data zone candidates, thereby determining at least one zone.

In the zone determining step, at least one zone may be determined randomly.

In the zone determining step, at least one zone may be determined so that a total playback time or a total recording time of the fourth data string in at least one zone is within a predetermined period of time.

In the first generating step, the third data string including information indicating a playback start position or a recording start position of the fourth data string defined by at least one zone may be generated.

In the first generating step, the third data string including information indicating a playback data zone or a recording data zone of the fourth data string defined by at least one zone may be generated.

The information processing method may further include a band determining step of determining a frequency band of the fourth data string to be played back or recorded by the first information processing apparatus. In the first generating step, the third data string that allows the fourth data string to be played back or recorded within the frequency band determined in the band determining step may be generated.

The first data may include data separated from the first data string when the second data string is generated from the first data string, or may include data replaced by second data which is different from the first data.

The information processing method may further include: a replacement step of replacing the first data contained in the first data string by second data which is different from the first data; a second generating step of generating the second data string by using data generated in the replacement step; and a third generating step of generating the fifth data string containing the first data.

In the replacement step, the first data contained in the first data string may be replaced by the second data so that the playback quality of the second data string becomes lower than the playback quality of the first data string.

The second data may be data in which at least part of the first data is replaced by random data.

The information processing method may further include a coding step of coding input data. In the replacement step, the first data contained in the first data string may be replaced by the second data by using the data coded in the coding step as the first data string.

The first data may contain normalizing-coefficient information used for coding processing in the coding step.

The first data may contain quantizing-precision information used for coding processing in the coding step.

The first data may contain variable-length codes.

The information processing method may further include a transform step of transforming frequency components. In the coding step, data transformed in the transform step may be coded, and the first data may contain spectrum-coefficient information.

The information processing method may further include a reception control step of controlling a signal to be received from the first information processing apparatus, the signal indicating a request for the third data string designating the playback quality or the recording quality of the fourth data string. In the first generating step, the third data string that allows the fourth data string to be played back or recorded with the playback quality or the recording quality designated by the signal may be generated.

According to another aspect of the present invention, there is provided an information processing apparatus including: an acquisition unit for acquiring a fifth data string containing data required for reconstructing a second data string into a first data string; a zone determining unit for determining at least one zone of a fourth data string to be played back or recorded by a first information processing apparatus; and a generator for generating a third data string to be distributed to the first information processing apparatus from the fifth data string acquired by the acquisition unit based on at least one zone determined by the zone determining unit.

A program recorded in a recording medium of the present invention includes: an acquisition control step of controlling the acquisition of a fifth data string containing data required for reconstructing a second data string into a first data string; a zone determining step of determining at least one zone of a fourth data string to be played back or recorded by a first information processing apparatus; and

a generating step of generating a third data string to be distributed to the first information processing apparatus from the fifth data string controlled to be acquired in the acquisition control step based on at least one zone determined in the zone determining step.

A program of the present invention includes: an acquisition control step of controlling the acquisition of a fifth data string containing data required for reconstructing a second data string into a first data string; a zone determining step of determining at least one zone of a fourth data string to be played back or recorded by a first information processing apparatus; and a generating step of generating a third data string to be distributed to the first information processing apparatus from the fifth data string controlled to be acquired in the acquisition control step based on at least one zone determined in the zone determining step.

According to the above-described information processing method, the information processing apparatus, the recording medium, and the program of the present invention, a data string to be transformed in the first information processing apparatus can be generated. A data string used for transforming a data string that allows data in only a predetermined zone to be played back or recorded in the first information processing apparatus can be generated.

According to a further aspect of the present invention, there is provided an information processing method including: a reception control step of controlling a third data string to be received from a first information processing apparatus; a replacement step of replacing first data contained in the third data string controlled to be received in the reception control step by second data contained in a second data string; and a generating step of generating a fourth data string to be played back or recorded in at least one zone by using data generated in the replacement step.

The third data string may include information indicating a playback start position or a recording start position of the fourth data string.

The third data string may include information indicating at least one zone when the fourth data string is played back or recorded.

The fourth data string may be played back or recorded in at least one zone with a quality equivalent to the first data string.

The fourth data string may be played back or recorded in at least one zone with an audio band narrower than the first data string and broader than the second data string.

In the replacement step, the first data may be replaced by the second data so that the playback quality or the recording quality of the fourth data string becomes higher than the playback quality or the recording quality of the second data string.

The information processing method may further include a decoding step of decoding the second data string. In the replacement step, the second data contained in the second data string may be replaced by the first data. In the decoding step, the fourth data string generated in the generating step may be decoded.

The second data string may be a coded data string, and the first data contained in the third data string may include normalizing-coefficient information.

The second data string may be a coded data string, and the first data contained in the third data string may include quantizing-precision information.

The information processing method may further include: a decoding step of decoding input data so as to transform the input data into frequency components; and an inverse transform step of inverse-transforming the frequency components transformed in the decoding step into signal components. The first data contained in the third data string may include spectrum-coefficient information of the frequency components.

The second data may be data in which at least part of the first data is replaced by random data.

The information processing method may further include a transmission control step of controlling a signal indicating a request for the third data string to be transmitted to the first information processing apparatus by designating the playback quality or the recording quality of the fourth data string generated in the generating step.

According to a yet further aspect of the present invention, there is provided an information processing apparatus including: a receiver for receiving a third data string from a first information processing apparatus; a replacement unit for replacing first data contained in the third data string received by the receiver by second data contained in a second data string; and a generator for generating a fourth data string to be played back or recorded in at least one zone by using data generated by the replacement unit.

A program recorded in a recording medium of the present invention includes: a reception control step of controlling a third data string to be received from a first information processing apparatus; a replacement step of replacing first data contained in the third data string controlled to be received in the reception control step by second data contained in a second data string; and a generating step of generating a fourth data string to be played back or recorded in at least one zone by using data generated in the replacement step.

A program of the present invention includes: a reception control step of controlling a third data string to be received from a first information processing apparatus; a replacement step of replacing first data contained in the third data string controlled to be received in the reception control step by second data contained in a second data string; and a generating step of generating a fourth data string to be played back or recorded in at least one zone by using data generated in the replacement step.

According to the above-described information processing method, the information processing apparatus, the recording medium, and the program of the present invention, a data string can be received and transformed into data that allows only a predetermined zone to be played back or recorded based on information contained in the received data string.

### BRIEF DESCRIPTION OF THE DRAWINGS

FIG. 1 is a block diagram illustrating a data transmitting/receiving system consisting of a coding device, a data playback device, and a data recording device to which the present invention is applied;

FIG. 2 is a block diagram illustrating the configuration of a coding device to which the present invention is applied;

FIG. 3 is a block diagram illustrating the configuration of a transformer shown in FIG. 2;

FIG. 4 illustrates a spectrum signal and a quantizing unit;

FIG. 5 is a block diagram illustrating the configuration of a signal component coder shown in FIG. 2;

FIG. 6 illustrates tone components and non-tone components;

FIG. 7 is a block diagram illustrating the configuration of a tone-component coder shown in FIG. 5;

FIG. 8 is a block diagram illustrating the configuration of a non-tone-component coder shown in FIG. 5;

FIG. 9 illustrates the format of a frame of original data;

FIG. 10 is a block diagram illustrating the configuration of a data separator shown in FIG. 2;

FIG. 11 illustrates the format of a sample frame;

FIG. 12 illustrates an additional frame;

FIG. 13 is a flowchart illustrating sample-data generation processing;

FIG. 14 illustrates an example of the frame of original data when tone components are not separated;

FIG. 15 illustrates a sample frame when tone components are not separated;

FIG. 16 illustrates an additional frame when tone components are not separated;

FIG. 17 is a block diagram illustrating the configuration of an additional-data transmitting device;

FIG. 18 is a flowchart illustrating additional-data transmission processing;

FIG. 19 illustrates responding additional data and sample playback data to be generated;

FIG. 20 illustrates high-quality playback data generated by additional data;

FIG. 21 is a block diagram illustrating the configuration of a data playback device to which the present invention is applied;

FIG. 22 is a block diagram illustrating the configuration of a signal component decoder shown in FIG. 21;

FIG. 23 is a block diagram illustrating the configuration of a tone-component decoder shown in FIG. 22;

FIG. 24 is a block diagram illustrating the configuration of a non-tone-component decoder shown in FIG. 22;

FIG. 25 is a block diagram illustrating the configuration of an inverse transformer shown in FIG. 21;

FIG. 26 is a flowchart illustrating sample-data playback processing;

FIG. 27 is a flowchart illustrating code-string reconstruction processing;

FIG. 28 is a flowchart illustrating high-quality playback processing;

FIG. 29 is a block diagram illustrating the configuration of a data recording device to which the present invention is applied;

FIG. 30 is a flowchart illustrating data recording processing; and

FIG. 31 is a block diagram illustrating the configuration of a personal computer.

### DESCRIPTION OF THE PREFERRED EMBODIMENTS

The present invention is described in detail below with reference to the accompanying drawings through illustration of an embodiment.

It is now assumed that, in response to the input of a digital signal, such as an audio PCM signal, high-efficiency coding is performed by conducting sub-band coding (SBC), adaptive transform coding (ATC), and adaptive bit allocation. ATC is a coding method in which bit allocation is adaptively performed based on, for example, DCT. More specifically, an input signal is transformed into spectrum signal components in units of time blocks, and the spectrum signal components in each band are normalized together. That is, each spectrum signal component is divided by a normalizing coefficient for approximating the maximum signal component. Then, the resulting signal components are quantized with quantizing precision, which is suitably determined by the characteristics of the signal components, and the quantized signal components are then coded.

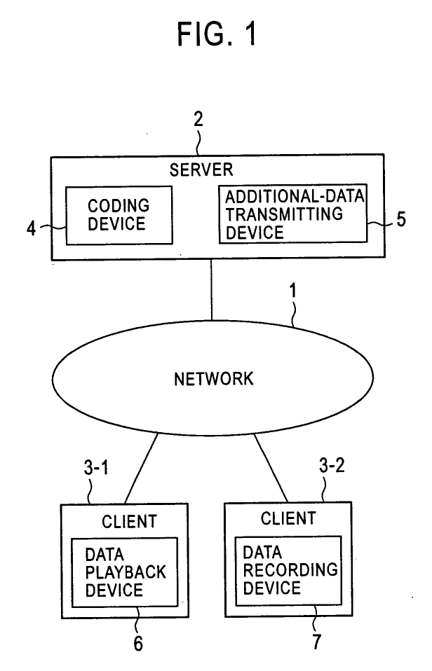

FIG. 1 is a block diagram illustrating a data transmitting/receiving system including a coding device, an additional-data transmitting device, a data playback device, and a data recording device to which the present invention is applied.

A server 2 is provided with a coding device 4 and an additional-data transmitting device 5. The coding device 4 generates sample data of content, or additional data for reconstructing original data by adding the additional data to the sample data. Then, the coding device 4 sends the sample data to a client 3-1 or 3-2 via a network 1 and also outputs the additional data to the additional-data transmitting device 5 via the network 1.

The additional-data transmitting device 5 stores additional data therein, and when receiving a request signal via the network 1 to send responding additional data for online sample or to send additional data for high-quality playback from the client 3-1 or 3-2 via the network 1, the additional-data transmitting device 5 transmits the corresponding additional data to the requested client 3-1 or 3-2 via the network 1. Details of the configurations of the coding device 4 and the additional-data transmitting device 5 are described below.

The client 3-1 is provided with a data playback device 6, which is described below. The data playback device 6 receives sample data from the coding device 4 of the server 2 via the network 1. The data playback device 6 requests the additional-data transmitting device 5 of the server 2 via the network 1 to send responding additional data for online sample or additional data for high-quality playback, and receives the corresponding additional data via the network 1. The data playback device 5 is then able to generate and play back online sample data or to reconstruct and play back original data by performing predetermined processing on the sample data by using the corresponding additional data.

The client 3-2 is provided with a data recording device 7, which is described below. The data recording device 7 receives sample data via the network 1. The data recording device 7 requests the additional-data transmitting device 5 to send high-quality playback additional data and receives it. The data receiving device 7 is then able to reconstruct original data by performing predetermined processing on the sample data by using the additional data, and records the original data on a recording medium, for example, a magneto-optical disk.

In this example, the client 3-1 possesses the data playback device 6, while the client 3-2 possesses the data recording device 7. Alternatively, the client 3-1 or 3-2 may possess both the data playback device 6 and the data recording device 7.

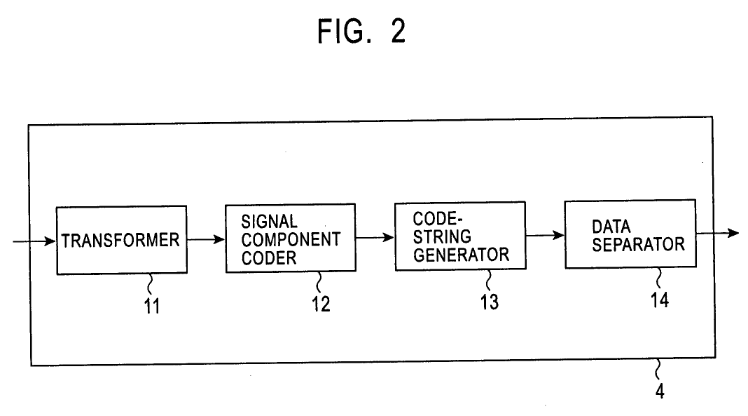

FIG. 2 is a block diagram illustrating the configuration of the coding device 4 for generating sample data in response to the input of an acoustic waveform signal.

Upon receiving an acoustic waveform signal, a transformer 11 transforms the acoustic waveform signal into signal frequency components and outputs them to a signal component coder 12. The signal component coder 12 codes the received signal frequency components, and outputs them to a code-string generator 13. The code-string generator 13 generates a code string from the coded signal frequency components, and outputs it to a data separator 14.

The data separator 14 performs predetermined processing, for example, changing normalizing-coefficient information or inserting dummy data, on the code string input from the code-string generator 13 so as to transform audio data (original data) that can be played back with high quality into sample data. If necessary, the data separator 14 sends the sample data to the client 3-1 or 3-2 possessed by the user via the network 1. The data separator 14 also generates additional data (reconstruction data) associated with the sample data, such additional data being sold to users that desire to play back the original data, and outputs the additional data to the additional-data transmitting device 5. Responding additional data to be distributed to users who desire to play back online sample data is generated in the additional-data transmitting device 5 based on the additional data output from the data separator 14.

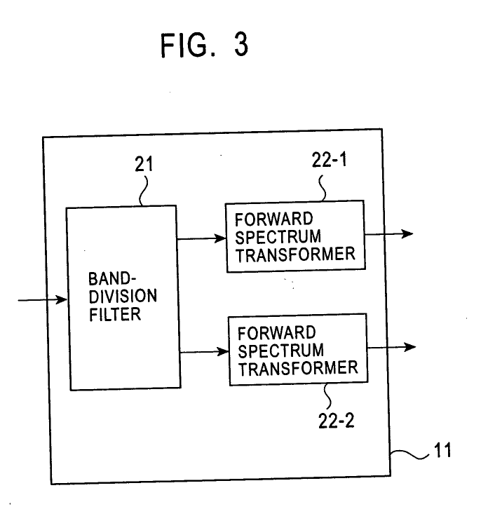

FIG. 3 is a block diagram illustrating the detailed configuration of the transformer 11.

An acoustic waveform signal input into the transformer 11 is divided into signal components in two bands by a band-division filter 21, and the signal components are output to forward spectrum transformers 22-1 and 22-2. The forward spectrum transformers 22-1 and 22-2 transform the signal components into spectrum signal components by using, for example, MDCT, and outputs them to the signal component coder 12. The bandwidth of the signal components input into the forward spectrum transformers 22-1 and 22-2 is one half the bandwidth of the signal input into the band-division filter 21. The signal input into the band-division filter 21 is also reduced to one half.

In the transformer 11 shown in FIG. 3, signal components divided into two bands by the band-division filter 21 are transformed into spectrum signal components by using MDCT. Another method may be employed for transforming an input signal into spectrum signal components. For example, an input signal may be transformed into spectrum signal components by using MDT without being divided into bands. Alternatively, the forward spectrum transformers 221 and 22-2 may transform the input signal into spectrum signal components by using DCT or DFT.

Although an input signal can be divided into band signal components by using a band-division filter, it is preferably transformed into spectrum signal components by using MDCT, DCT, or DFT, which allows many frequency components to be computed with a relatively small amount of computation.

Although in FIG. 3 the input acoustic waveform signal is divided into two bands in the band-division filter 21, it may be divided into three or more bands. Information concerning the number of bands divided in the band-division filter 21 is output to the code-string generator 13 via the signal component coder 12.

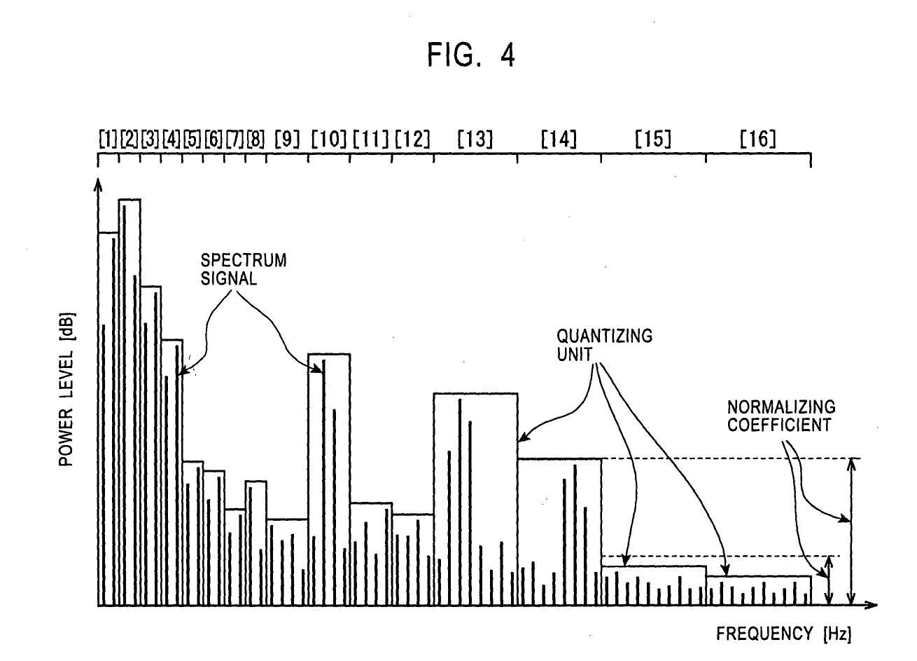

FIG. 4 illustrates a spectrum signal obtained by converting the absolute values of the spectrum signal components subjected to MDCT processing by the transformer 11 into power levels.

The acoustic waveform signal input into the transformer 11 is transformed into, for example, 64 spectrum signal components in units of predetermined time blocks. These spectrum signal components are divided into 16 bands, such as [1] through [16] indicated by solid rectangles in FIG. 4, according to processing, which are described below, by the signal component coder 12, and the spectrum signal components in each band are then quantized and normalized. A set of spectrum signal components divided into 16 bands, that is, a set of spectrum signal components to be subjected to quantization and normalization together, is a quantizing unit.

By changing the quantizing precision in each quantizing unit based on the distribution of frequency components, high-efficiency coding can be performed with very little degradation of the audio quality perceptible to human ears. Thus, when coding acoustic waveform signals, coding parameters, such as quantizing precision, can be controlled to improve the coding efficiency by utilizing human acoustic characteristics.

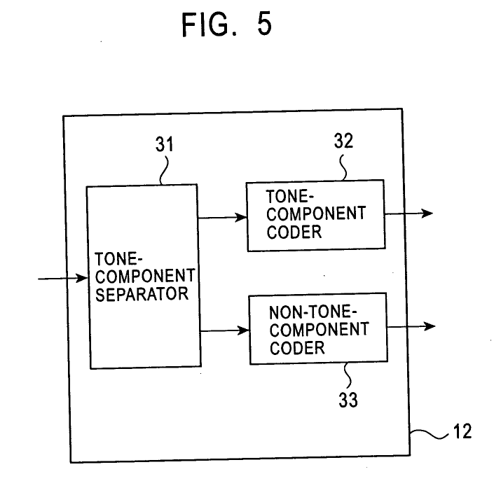

FIG. 5 is a block diagram illustrating the detailed configuration of the signal component coder 12. In the signal component coder 12 shown in FIG. 5, tone components that are particularly important in an acoustic sense, i.e., signal components having energy concentrated in specific frequencies, are extracted from the input spectrum signal, and are separately coded from the other spectrum components.

A spectrum signal received from the transformer 11 is separated into tone components and non-tone components by a tone-component separator 31. The tone components are output to a tone-component coder 32, and the non-tone components are output to a non-tone-component coder 33.

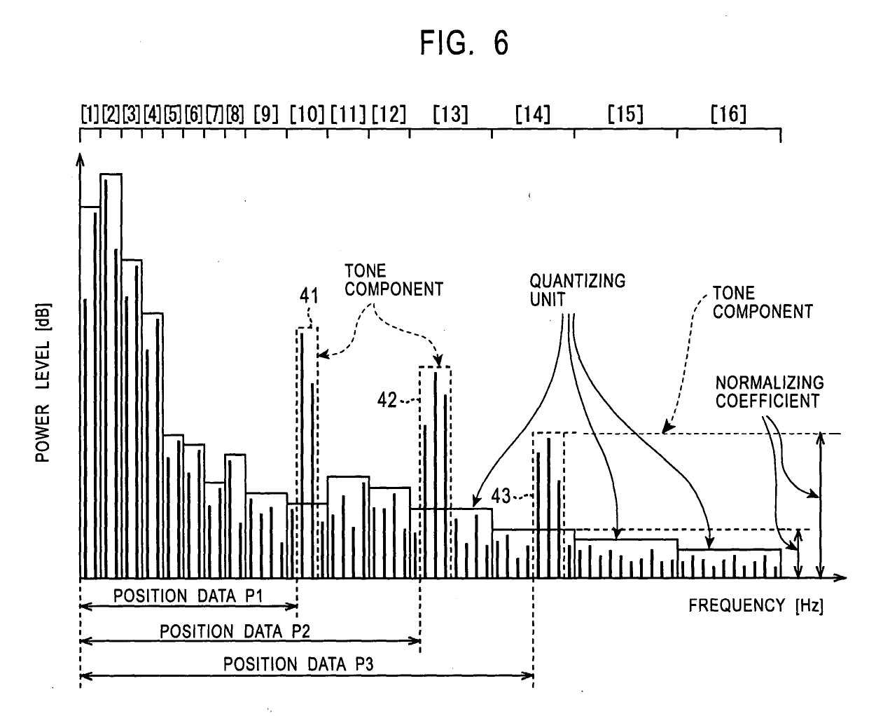

Tone components and non-tone components are described in detail below with reference to FIG. 6. It is now assumed that the spectrum signal input into the tone-component separator 31 is the signal shown in FIG. 6. In this case, signal components having high power levels are separated from non-tone components as tone components 41 through 43. Position data P1 through P3 indicating the positions of the separated tone components 41 through 43 and the bandwidths of the tone components 41 through 43 are detected and output to the tone-component coder 32 together with the tone components 41 through 43.

Tone components may be separated by using, for example, the method disclosed in Japanese Patent Application No. 5-152865, WO94/28633, or U.S. Pat. No. 5,717,821 filed by the present inventors. The tone components and the non-tone components separated by this method are quantized with different numbers of bits by the processing of the tone-component coder 32 and the non-tone-component coder 33, respectively, which are described below.

The tone-component coder 32 and the non-tone-component coder 33 code the input signal components.

It is necessary to add information concerning, for example, the positions and the bandwidths of the extracted tone components, to the tone components. However, in particular, if an acoustic waveform signal input into the coding device 4 is a signal having energy concentrated in specific frequencies, it can be coded effectively with a high compression ratio with very little degradation in an acoustic sense by using the above-described method.

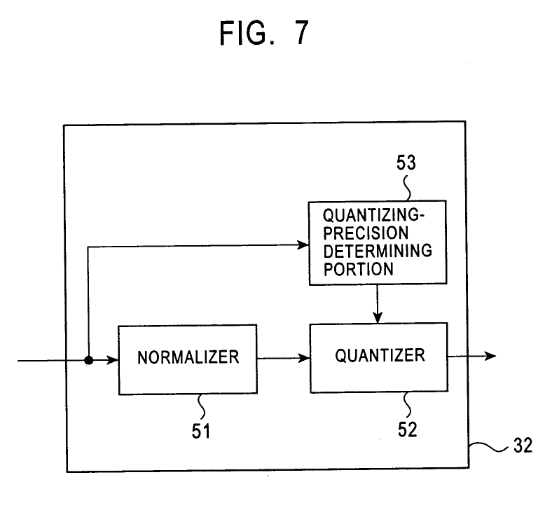

FIG. 7 is a block diagram illustrating the detailed configuration of the tone-component coder 32.

A normalizer 51 receives tone components, normalizes them, and outputs the normalized components to a quantizer 52. A quantizing-precision determining portion 53 calculates the quantizing precision by referring to the quantizing unit of an input spectrum signal, and outputs the calculation result to the quantizer 52. The quantizer 52 quantizes the normalized result input from the normalizer 51 with the quantizing precision determined by the quantizing-precision determining portion 53 so as to generate codes. The quantizer 52 also outputs coding information, such as normalizing-coefficient information and quantizing-precision information, together with the generated codes.

The tone-component coder 32 also codes position information concerning the positions of the tone components, input together with the tone components, and outputs the coded information.

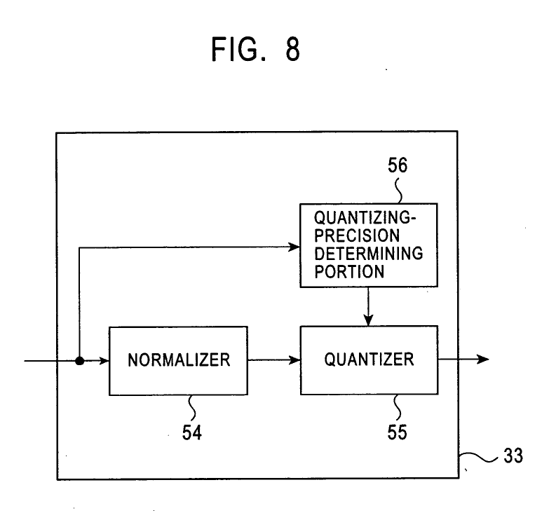

FIG. 8 is a block diagram illustrating the detailed configuration of the non-tone-component coder 33.

A normalizer 54 receives non-tone components in each quantizing unit, normalizes them, and outputs the normalized components to a quantizer 55. A quantizing-precision determining portion 56 calculates the quantizing precision by referring to the quantizing unit of an input spectrum signal, and outputs a calculated result to the quantizer 55. The quantizer 55 quantizes the normalized result input from the normalizer 54 with the quantizing precision determined by the quantizing-precision determining portion 56 so as to generate codes. The quantizer 55 also outputs coding information, such as normalizing-coefficient information and quantizing-precision information, together with the generated codes.

The coding efficiency achieved by the above-described coding method can be-further improved. For example, variable-length coding is used, and among quantized spectral components, a relatively short code length can be assigned to signal components which appear with higher frequency, and a relatively long code length can be assigned to signal components which appear with lower frequency, thereby enhancing the coding efficiency.

Then, the code-string generator 13 shown in FIG. 2 generates a code string consisting of a plurality of frames that can be recorded in a recording medium or transmitted to another information processing apparatus via a data transmission channel from the codes of the signal frequency components output from the signal component coder 12, and outputs the code string to the data separator 14. The code string generated by the code-string generator 13 is audio data that can be played back with high quality by regular decoders.

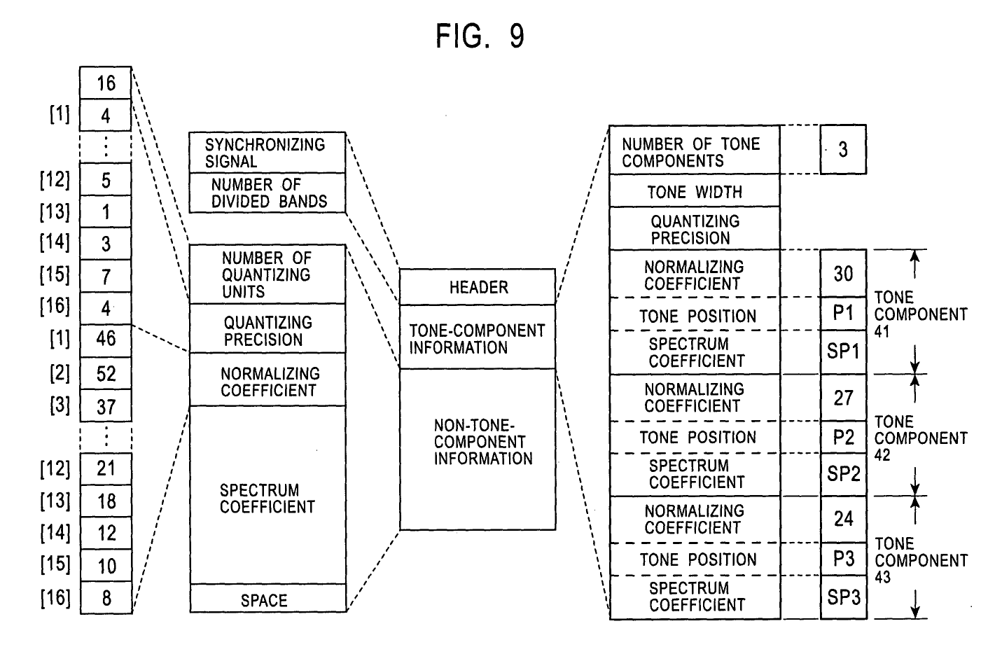

FIG. 9 illustrates an example of the format of the frame of the audio data that is generated by the code-string generator 13 and that can be played back with high quality.

At the head of each frame, a fixed-length header containing a synchronizing signal is disposed. The header also contains the number of bands divided in the band-division filter 21 of the transformer 11 described with reference to FIG. 3.

In each frame, after the header, tone-component information concerning separated tone components is recorded. The tone-component information includes the number of tone components (3 in this example), the tone width, and information concerning the quantizing precision used for quantizing the tone components by the tone-component coder 32 shown in FIG. 7. Subsequently, the tone-component information includes data of the tone components 41 through 43, such as the normalizing coefficients, the tone positions, and the spectrum coefficients. In this example, for the tone component 41, the normalizing coefficient is 30, the tone position is P1, and the spectrum coefficient is SP1; for the tone component 42, the normalizing coefficient is 27, the tone position is P2, and the spectrum coefficient is SP2; and for the tone component 43, the normalizing coefficient is 24, the tone position is P3, and the spectrum coefficient is SP3.

Subsequent to the tone-component information, non-tone-component information is recorded. The non-tone-component information includes the number of quantizing units (16 in this example), and the quantizing-precision information, the normalizing-coefficient information, and the spectrum-coefficient information of each of the 16 quantizing units when the non-tone components are coded by the non-tone-component coder 33 shown in FIG. 8. As the quantizing-precision information, the value of 4 is assigned to the quantizing unit [1] in the lowest band, and the value of 4 is assigned to the quantizing unit [16] in the highest band. As the normalizing-coefficient information, the value of 46 is assigned to the quantizing unit [1] in the lowest band, and the value of 8 is assigned to the quantizing unit [16] in the highest band.

As the normalizing-coefficient information, values proportional to the dB values of the power levels of the spectrum signal are used. If the length of the content frame is fixed, a space may be created after the spectrum-coefficient information.

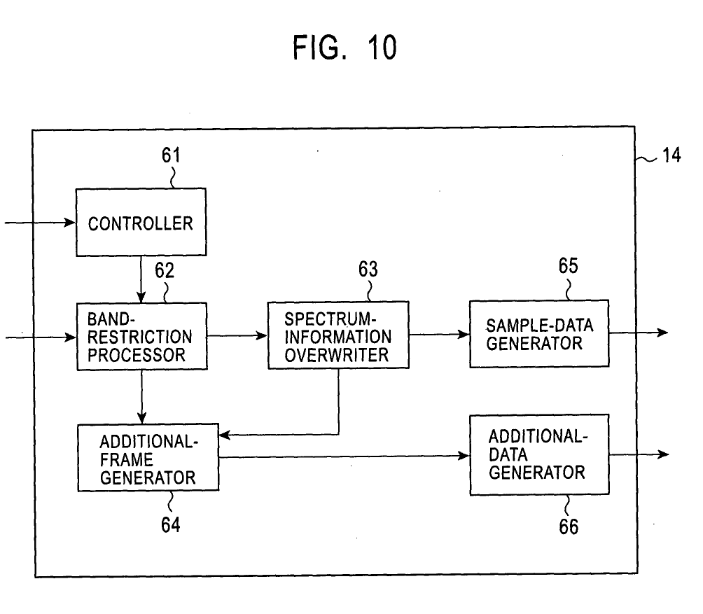

FIG. 10 is a block diagram illustrating the detailed configuration of the data separator 14 shown in FIG. 2.

A controller 61 controls a band-restriction processor 62 based on setting data for the time length of an offline sample zone of sample data and for the frequency band of the sample data, which are input from an external operation input unit (not shown). The offline sample zone is a portion that can be played back with low quality when sample data is played back offline without being connected to the network 1, i.e., when sample data is played back without using additional data or responding additional data. The frequency band of sample data is the frequency band in which the sample data is played back with low quality. For example, by designating some quantizing units of the spectrum data shown in FIG. 6, only a predetermined frequency band can be played back, so that the audio quality of the offline sample zone data becomes lower than that of the original data or the online sample data.

The data of the offline sample zone is designated by the start position of the zone, the time length of the zone (sample zone length), and the frequency band in the zone (sample band). The offline sample zone may be specified in a plurality portions in the sample data.

The band-restriction processor 62 generates, from the coded frames corresponding to the offline sample zone, data restricted in the designated sample band based on information concerning the offline sample zone input from the controller 61. For example, the band-restriction processor 62 designates some quantizing units of the spectrum data shown in FIG. 6 based on the sample band so that only a predetermined frequency band can be played back, thereby decreasing of the quality of the audio data to be played back.

For example, when the sample band of the offline sample zone is set to be 0 so as to prevent sound from being output when the sample data is played back, the controller 61 informs the band-restriction processor 62 that the sample band of the offline sample zone is 0. The band-restriction processor 62 minimizes the normalizing coefficients of the non-tone components of the quantizing units [1] through [16] to, for example, zero, so as to replace the normalizing coefficients by dummy data. The band-restriction processor 62 then outputs the true values of the normalizing coefficients of the quantizing units [1] through [16] to an additional-frame generator 64.

The band-restriction processor 62 also minimizes the normalizing coefficients of the tone components of the quantizing units outside the sample band to, for example, zero, and replaces the normalizing coefficients by dummy data. The band-restriction processor 62 then outputs the true values of the normalizing coefficients corresponding to the dummy data to the additional-frame generator 64.

By minimizing the normalizing coefficients, the corresponding spectrum coefficients are also minimized almost to 0 when the sample data is played back. Although they are not exactly 0, it is almost the same as 0 in terms of audibility. Accordingly, certain information can be recorded in the areas in which the spectrum coefficient information corresponding to the minimized normalizing coefficients is indicated. If the sample band of the offline sample zone is set to be 0 to prevent sound from being output when the sample data is played back, information can be recorded in all the areas in which the spectrum coefficient information is indicated.

Thus, a spectrum-information overwriter 63 replaces part of or the entire spectrum coefficient information corresponding to the minimized normalizing coefficients by random dummy data, and outputs the true values of the spectrum-coefficient information replaced by the dummy data and, if necessary, the positions at which the dummy data is indicated (positions at which the real spectrum-coefficient information is placed) to the additional-frame generator 64.

In the frames outside the offline sample zone, the band-restriction processor 62 separates or minimizes all the normalizing coefficients, and outputs the true values of the normalizing coefficients to the additional-frame generator 64. Alternatively, the band-restriction-processor 62 separates all the frames outside the offline sample zone from the frame string, and outputs the separated frames to the additional-frame generator 64. Accordingly, the frames outside the offline sample zone are not played back in the offline sample data.

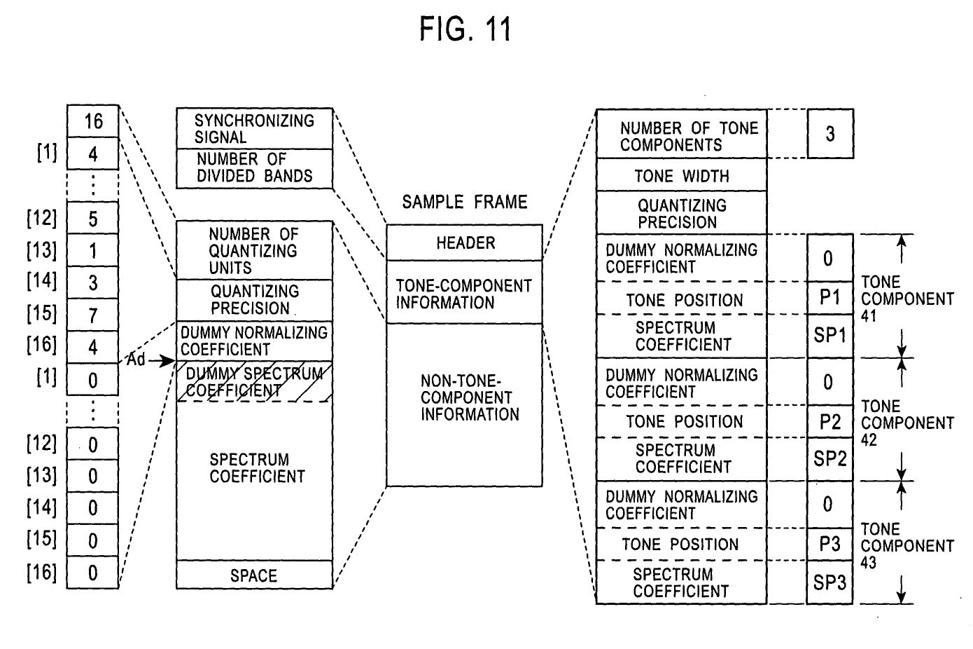

FIG. 11 illustrates a sample frame in which the band is restricted by the band-restriction processor 62, and part of the spectrum-coefficient information corresponding to the minimized normalizing coefficients is replaced by random dummy data by the spectrum-information overwriter 63.

It is now assumed, in the sample frame shown in FIG. 11, that the sample band of the offline sample zone is set to be 0 so as to prevent sound from being output when the sample data is played back.

That is, in this sample frame, all the normalizing coefficients are replaced by 0. Accordingly, since all the corresponding items of the spectrum-coefficient information are not referred to when the sample data is played back, part of the area higher than the head (indicated by Ad in FIG. 11) of the area in which the spectrum-coefficient information is indicated is replaced by dummy data (dummy spectrum-coefficient information).

In the sample frame shown in FIG. 11, the sample band of the offline sample zone is set to be 0 so as to prevent sound from being output when the sample data is played back. Alternatively, if, for example, the quantizing units [1] through [12] are designated as the sample band of the offline sample zone, the band-restriction processor 62 minimizes the normalizing coefficients of the quantizing units [13] through [16] higher than the sample band to, for example, 0, and outputs the true values of the normalizing coefficient information of the quantizing units [13] through [16] to the additional-frame generator 64. Accordingly, although the significant values are indicated in the spectrum-coefficient information corresponding to the quantizing units [13] through [16], they become substantially 0 when the sample data is played back since the corresponding normalizing-coefficient information is 0. As stated above, although the spectrum coefficients do not become exactly 0, they are almost the same as 0 in terms of the audibility.

As in the non-tone components, the band-restriction processor 62 also minimizes the normalizing coefficients of the tone components outside the sample band to, for example, 0. Accordingly, the spectrum signal components of the corresponding tone components are also minimized (substantially the same as 0). When such sample data is decoded and played back, only the narrow-band spectrum signal corresponding to the quantizing units [1] through [12] is played back. Accordingly, the sample data is played back with lower quality than that of the original data shown in FIG. 9.

Dummy data to replace spectrum-coefficient information may be inserted into all the frames or into some of the frames.

If variable-length coding is performed on the spectrum-coefficient information, and if the variable-length codes are sequentially recorded in the spectrum-coefficient information area from the lower band to the higher band, part of the variable-length codes in the intermediate band is missing, since the spectrum-coefficient information which is not referred to is replaced by dummy data. This makes it impossible to decode the higher-band data including the intermediate-band data. That is, it is very difficult to reconstruct the spectrum-coefficient information of the original data contained in the sample data without using the additional data. As a result, the security of the sample data can be enhanced.

When part of the normalizing-coefficient information or part of the spectrum-coefficient information is missing or replaced by other information, it is very difficult to predict the true data compared to when a relatively short encryption key is broken. Illegal falsification of the sample data results in a deterioration in the audio quality. Accordingly, it is very difficult for users who are not permitted to play back original data to predict the original data based on the sample data, thereby enhancing the protection of the copyright of the creator or the distributor of the content data.

Even if true values replaced by dummy data in sample data are predicted from dummy data, there is no danger of expanding such damage to other items of content, unlike when an encryption algorithm is broken. Thus, a higher level of security can be achieved compared to when content data is encrypted by using a specific algorithm and is distributed as sample data.

Then, the true values of the normalizing-coefficient information and the true values of the spectrum-coefficient information replaced by dummy data by the band-restriction processor 62 or the spectrum-information overwriter 63 are supplied to the additional-frame generator 64, and are indicated in an additional frame. Instead of changing the normalizing-coefficient information, the band-restriction processor 62 may replace the quantizing-precision information or the number of quantizing units by 0 or random dummy data. In this case, the additional-frame generator 64 receives information indicating, for example, the quantizing-precision information or the number of quantizing units, replaced by the band-restriction processor 62, and indicates such information in an additional frame.

However, changing the normalizing-coefficient information is different from changing the quantizing-precision information in terms of the security level, that is, the difficulty in illegally predicting the original data from the sample data without using the additional data. For example, when the original data is generated by using a bit allocation algorithm in which the quantizing-precision information is calculated based on the normalizing-coefficient information, and if, in this case, only the quantizing-precision information is changed, the true values of the quantizing-precision information may be predicted based on the normalizing coefficient information.

In contrast, it is difficult to predict the normalizing-coefficient information from the quantizing-precision information. It is thus preferable that the normalizing-coefficient information be changed in view of security. By changing both the normalizing-coefficient information and the quantizing-precision information, the possibility of the original data being illegally predicted becomes extremely low. Alternatively, the normalizing-coefficient information or the quantizing-precision information may be selectively changed in each content frame of the sample data.

Based on the true values of the normalizing-coefficient information supplied from the band-restriction processor 62 and the true values of the spectrum-coefficient information and position information thereof supplied from the spectrum-information overwriter 63, the additional-frame generator 64 generates an additional frame which forms additional data used for reconstructing original data to be purchased by a user who desires to listen to a piece of music with high quality after listening to the sample data.

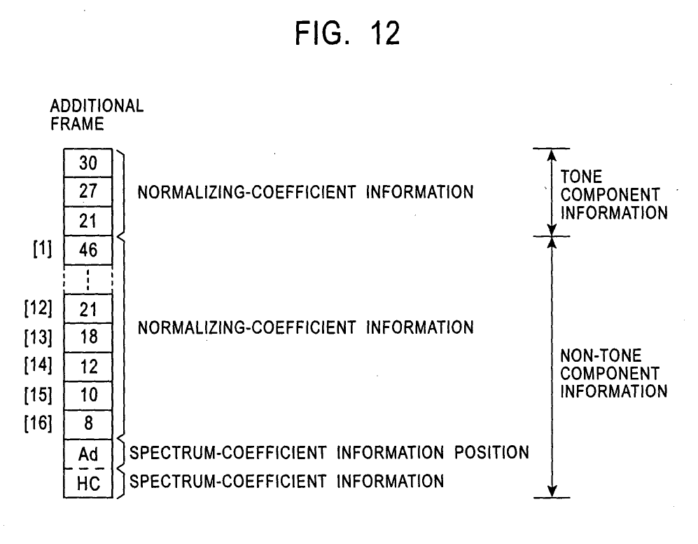

FIG. 12 illustrates the format of an additional frame to be generated.

As discussed with reference to FIG. 11, when the sample band of the offline sample zone is set to be 0, the normalizing coefficients of the tone components and the non-tone components corresponding to 16 quantizing units, such as quantizing units [1] through [16], are replaced by a dummy normalizing coefficient of 0. Part of the spectrum-coefficient information which is not referred to is also replaced by dummy data. The additional-frame generator 64 receives the true values of the normalizing-coefficient information replaced by dummy data from the band-restriction processor 62 and also receives the true values of the spectrum-coefficient information replaced by dummy data from the spectrum-information overwriter 63 so as to generate the additional frame shown in FIG. 12.

In the additional frame, additional information corresponding to the tone components and additional information corresponding to the non-tone components are indicated. FIG. 12 illustrates the additional frame to be generated when the sample band of the offline sample zone is set to be 0. As the additional information associated with the tone components, the true values (in this example, the values 30, 27, and 21) of the minimized normalizing-coefficient information of the tone components are recorded. As the additional information associated with the non-tone components, the true values (in this example, the true normalizing coefficients corresponding to 16 quantizing units, such as the quantizing units [1] through [16]) of the minimized normalizing-coefficient information of the non-tone components, and the true values of the spectrum-coefficient information (in this example, HC) replaced by dummy data and position information (in this example, Ad) thereof are recorded.

In the example shown in FIG. 12, the position information of the true spectrum-coefficient information replaced by dummy data is indicated in the additional frame to be generated. However, the position at which the spectrum-coefficient information is replaced by dummy data can be located at the head of the spectrum-coefficient information that is not referred to, thereby making it possible to determine the position of the true spectrum-coefficient information replaced by dummy data from information concerning the quantizing units whose normalizing coefficients are replaced by 0. On the other hand, if the position at which the spectrum-coefficient information replaced by dummy data is located in a portion different from the head of the spectrum-coefficient information that is not referred to, it is necessary to indicate the position information of the spectrum-coefficient information replaced by dummy data in the additional frame, as shown in FIG. 12.

If the band-restriction processor 62 changes information other than the normalizing-coefficient information or the spectrum-coefficient information, for example, the quantizing-precision information or the number of quantizing units, the additional-frame generator 64 receives information indicating the values changed by the band-restriction processor 62, and indicates the true values of the corresponding information in the additional frame.

By recording part of or the entirety of the normalizing-coefficient information to be indicated in an additional frame in a space of the sample frame, the amount of the resulting additional data or the responding additional data can be reduced, thereby decreasing the time required for downloading the additional data or the responding additional data. If part of or the entirety of the normalizing-coefficient information to be indicated in an additional frame is recorded in a space of the sample frame, it is not recorded in the additional frame.

A sample-data generator 65 generates the header of sample data, and adds the generated header to the coded frames of the sample data so as to generate and output sample data. The header of the sample data contains information concerning, for example, a content ID for identifying the content, the content playback time, the content title, and the coding method.

An additional-data generator 66 generates the header of additional data, and adds the generated header to the additional frames so as to generate and output additional data. The header of the additional data includes information concerning, for example, a content ID for identifying the content to distinguish the additional data from the sample data, the content playback time, and the coding method if necessary.

By using the sample data and the additional data generated by the data separator 14, original data can be reconstructed according to the processing described below.

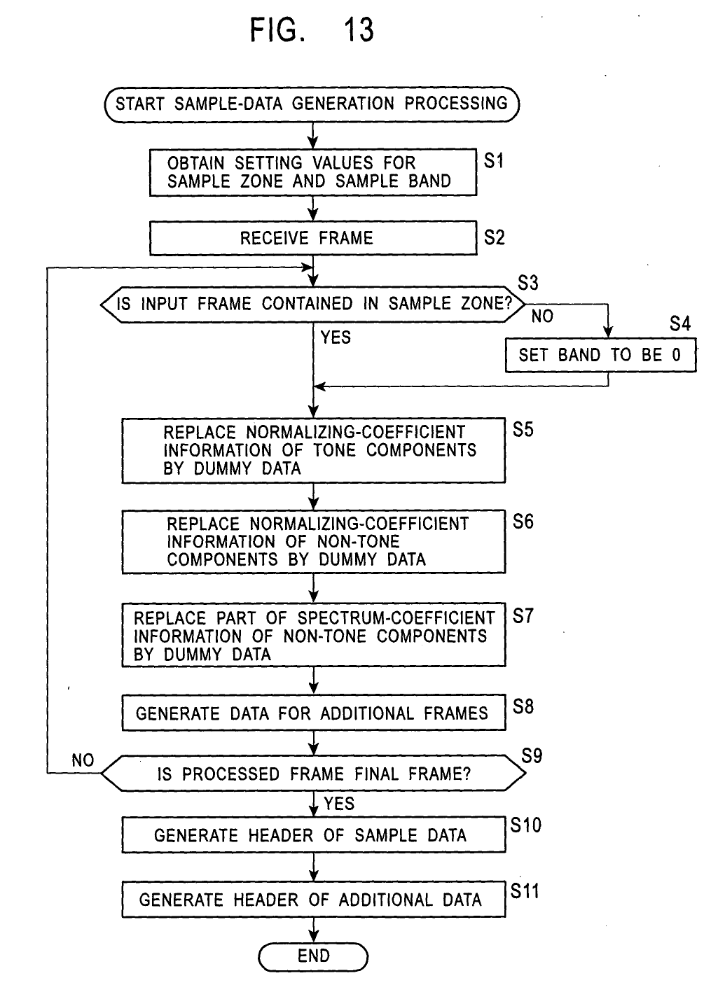

Sample-data generation processing is described below with reference to the flowchart of FIG. 13.

In step S1, the controller 61 obtains setting values for an offline sample zone (start position and zone length) of sample data and for the sample band, input from an operation input unit (not shown). It is assumed, in this example, that the sample band is set to be 0, and that the start position of the sample data is the head of content data, and the zone length is equal to the length of the content data. The controller 61 supplies the setting values for the sample band to the band-restriction processor 62.

In step S2, the band-restriction processor 62 receives a frame forming the original data, that is, a frame that can be played back with high quality, such as that shown in FIG. 9. In step S3, it is determined whether the input frame is contained in the offline sample zone based on the information supplied from the controller 61.

If it is found in step S3 that the input frame is not contained in the offline sample zone, it means that it is a frame that cannot be previewed or listened to offline. Then, the process proceeds to step S4 in which the band is set to be 0 so as to prevent the frame which is not contained in the offline sample zone from being played back in the offline sample data. The process then proceeds to step S5. Alternatively, the frames outside the offline sample zone may be separated and are output to the additional-frame generator 64 so as to prevent the frames from being played back.

If it is determined in step S3 that the input frame is contained in the offline sample zone, or after step S4, the process proceeds to step S5. In step S5, the band-restriction processor 62 replaces the normalizing-coefficient information of the tone components of the input frame other than the normalizing-coefficient information in the band designated by the setting values for the sample band supplied from the controller 61 by dummy data, for example, the value of 0. Then, in step S6, the band-restriction processor 62 replaces the normalizing-coefficient information of the non-tone components of the input frame other than the normalizing-coefficient information of the band designated by the setting values for the sample band supplied from the controller 61 by dummy data, for example, the value of 0. The band-restriction processor 62 also outputs all the true values of the normalizing-coefficient information replaced in steps S5 and S6 and various information, for example, position information thereof, to the additional-frame generator 64. Alternatively, the band-restriction processor 62 outputs part of the information to the spectrum-information overwriter 63 and outputs the rest of the information to the additional-frame generator 64.

In step S7, the spectrum-information overwriter 63 replaces part of the spectrum-coefficient information that is not referred to and is associated with the normalizing-coefficient information of the non-tone components replaced in step S6 by dummy data (dummy spectrum-coefficient information) which is impossible to predict the true values, thereby generating a sample frame, such as that shown in FIG. 11. The spectrum-information overwriter 63 then outputs the generated sample frame to the sample-data generator 65, and also outputs the true spectrum-coefficient information replaced by dummy data in step S7 to the additional-frame generator 64.

If variable-length coding is performed on spectrum-coefficient information, dummy data whose bit length becomes shorter than that of the true spectrum-coefficient information when being decoded is used. Accordingly, a frame length does not exceed the coded frame length when being decoded.

The spectrum-information overwriter 63 may record various control information in part of the spectrum-coefficient information that is not referred to. Dummy data to replace the spectrum-coefficient information may be solely the value of 0, or may be the values of 1s and 0s.

In step S8, based on the signals input from the band-restriction processor 62 and the spectrum-information overwriter 63, the additional-frame generator 64 generates data for an additional frame which is purchased by a user who desires to listen to a piece of music with high quality after listening to the sample data.

In step S9, the sample-data generator 65 determines whether the processed frame is the final frame. If the outcome of step S9 is no, the process returns to step S2, and step S2 and the subsequent steps are repeated.

If it is determined in step S9 that the processed frame is the final frame, the process proceeds to step S10 in which the sample-data generator 65 generates a header for sample data and adds it to the sample frames by using the input information so as to generate and output sample data.

In step S11, the additional-data generator 66 generates a header for additional data by using the input information and adds it to the additional frames so as to generate and output additional data. The processing is then completed.

According to the processing described with reference to the flowchart of FIG. 13, offline sample data in which only the sample zone is played back with low quality (if the setting value of the sample zone is 0, sound is not heard), and additional data for reconstructing original data from the offline sample data can be generated.

As described above, the signal component coder 12 of the coding device 4 separates an input signal into tone components and non-tone components, and codes them separately. However, by using the non-tone-component coder 33 shown in FIG. 8 instead of the signal component coder 12, an input signal may be coded without being separated into tone components and non-tone components.

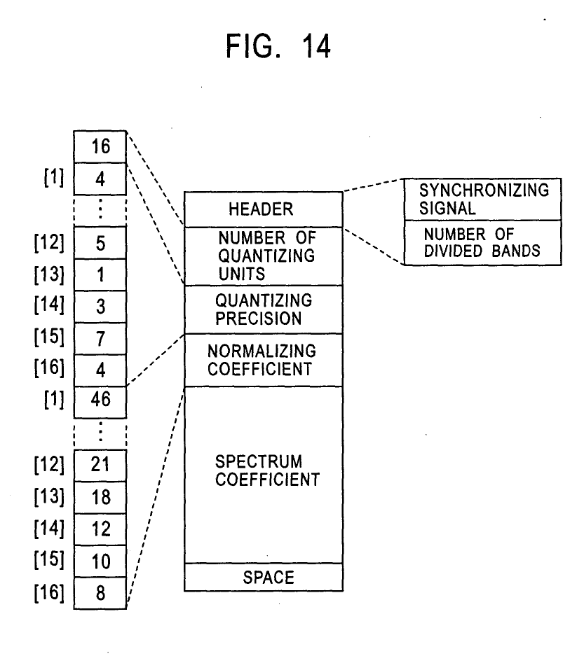

FIG. 14 illustrates an example of the format of a high-quality original data frame generated by the code-string generator 13 when an input signal is not separated into tone components and non-tone components. As in FIG. 9, at the head of the original data frame, a fixed-length header including a synchronizing signal is disposed. In the header, the number of bands divided in the band-division filter 21 of the transformer 11 shown in FIG. 3 is recorded. Subsequent to the header, the number of quantizing units (in this example, 16), the quantizing-precision information concerning the quantization performed by the non-tone-component coder 33, the normalizing-coefficient information of each of the 16 quantizing units, and the spectrum-coefficient information are recorded. As the normalizing-coefficient information, the value of 46 is assigned to the quantizing unit [1] in the lowest band, and the value of 8 is assigned to the quantizing unit [16] in the highest band. If the length of the content frame is fixed, a space may be created after the spectrum-coefficient information.

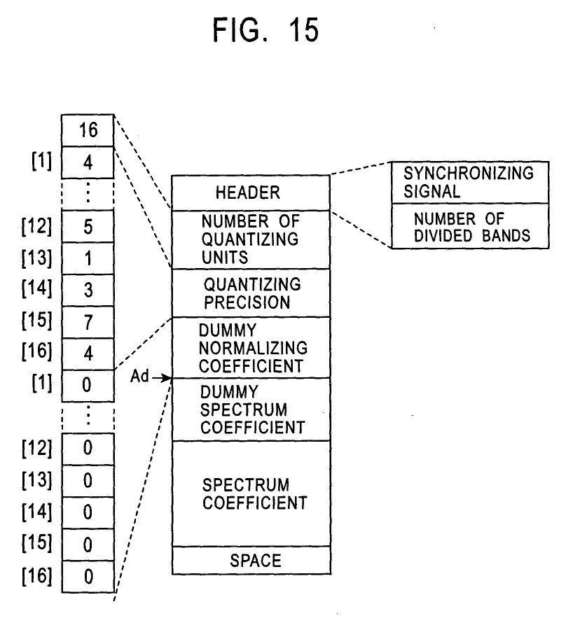

FIG. 15 illustrates an example of the format of a sample frame generated by the data separator 14, which receives the input of the original data frame shown in FIG. 14. If, for example, the sample band of the offline band zone is set to be 0, the normalizing-coefficient information of the quantizing units higher than the sample band, i.e., the normalizing-coefficient information of all the quantizing units, becomes 0. Accordingly, although the significant values are indicated in the spectrum-coefficient information of all the quantizing units, they become substantially 0 when the sample data is played back since the corresponding normalizing-coefficient information is 0. Dummy data (dummy spectrum-coefficient information) is also recorded in part of the spectrum coefficients which are not referred to.

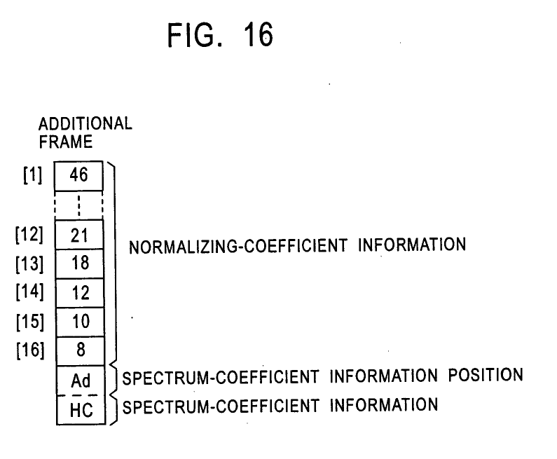

FIG. 16 illustrates an additional frame generated by the additional-frame generator 64 of the data separator 14, which receives the input of the original frame shown in FIG. 14. It is now assumed that the sample band of the offline sample zone is set to be 0. In the additional frame shown in FIG. 16, the minimized normalizing coefficients of the quantizing units, i.e., all the true values of the normalizing coefficients, and the true values of the spectrum-coefficient information replaced by dummy data are indicated.

As described with reference to FIGS. 14 through 16, when a spectrum signal is not separated into tone components and non-tone components, sample data in which only a sample zone is played back with low quality, and additional data for reconstructing the original data from the sample data can be generated according to processing similar to that described above.

The sample data generated as described above is distributed to users via the Internet or is recorded in various recording media possessed by users by using MMK installed in a store. If a user likes the content after previewing or listening to the sample data, the user is able to obtain additional data by paying a predetermined amount of money to the distributor of the content data. The user is able to reconstruct the original data by increasing the quality of the sample data by using the sample data and the obtained additional data so as to decode and play back the high-quality data or to record it in a recording medium.

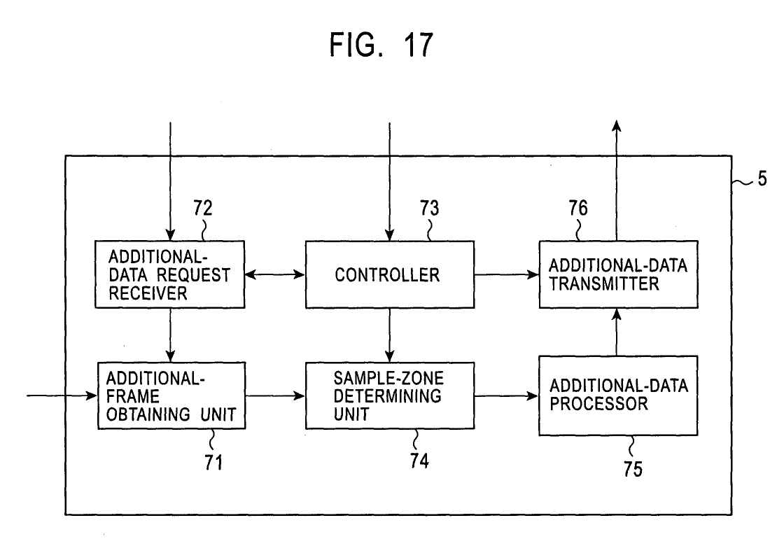

FIG. 17 is a block diagram illustrating the configuration of the additional-data transmitting device 5.

The additional-data transmitting device 5 receives a request to send additional data from the user of the data playback device 6 or the data recording device 7 offline while being connected to the data playback device 6 or the data recording device 7 by wired or wireless means via the network 1. The additional-data transmitting device 5 then generates, from the additional data supplied from the coding device 4, responding additional data for reconstructing online sample data, and sends via the network 1 the generated responding additional data or high-quality playback additional data to the data playback device 6 or data recording device 7 that has sent the request.

The sample zone that can be played back or recorded with higher quality than the offline sample data by using the responding additional data for reconstructing the online sample data is referred to as the “online sample zone”. The sample band, the sample-zone start position, and the sample zone length of the online sample zone are set by the additional-data transmitting device 5.

Based on an additional-data request packet sent from the data playback device 6 or the data recording device 7 via the network 1, an additional-data request receiver 72 specifies content for which the additional data or the responding additional data is requested based on the content ID, and outputs the corresponding data to an additional-frame obtaining unit 71 and a controller 73, together with information indicating whether the responding additional data for reconstructing the online sample data or the high-quality playback additional data is requested.

The additional-data request packet sent from the data playback device 6 or the data recording device 7 via the network 1 contains information, for example, an content ID or a title for specifying the content, which is similar to the information for identifying the content contained in the header information of the sample data or the additional data.

The additional-frame obtaining unit 71 obtains frames of the additional data (which is generated in the coding device 4) associated with the content specified by the additional-data request receiver 72, and outputs the frames to a sample-zone determining unit 74.

The controller 73 controls the additional-data request receiver 72 and an additional-data transmitter 76 so as to perform required communication with the data playback device 6 or the data recording device 7 that has sent the additional-data request packet. The controller 73 also receives the input of an operation concerning the type of playback operation for the online sample zone, which is input from the content provider (that is, the administrator of the server 2) through an operation input unit (not shown), and controls the sample-zone determining unit 74 to determine the online sample zone based on the received operation. The controller 73 also sets the number of online sample zones, and supplies the corresponding information to the sample-zone determining unit 74.

Under the control of the controller 73, the sample-zone determining unit 74 determines the sample zone, extracts required additional frames from all the additional frames supplied from the additional-frame obtaining unit 71, and supplies the extracted frames to an additional-data processor 75. More specifically, when the data playback device 6 or the data recording device 7 requests the sample data to be played back or recorded, the sample-zone determining unit 74 determines the online sample zone, and also, determines whether the additional frames of the additional data supplied from the additional-frame obtaining unit 71 are contained in the online sample zone, and supplies only the additional frames contained in the online sample zone to the additional-data processor 75. If the data playback device 6 or the data recording device 7 requests a high-quality playback or recording operation, i.e., a playback or recording operation of the original data, the sample-zone determining unit 74 supplies all the additional frames to the additional-data processor 75.

The content provider (i.e., the administrator of the server 2 shown in FIG. 1) may set a zone to be recommended, for example, for each item of content as the online sample zone, and stores such zones in a memory built in the sample-zone determining unit 74. The sample-zone determining unit 74 receives, via the controller 73, for example, the content ID, contained in the additional-data request packet received by the additional-data request receiver 72, reads information concerning the preset online sample zone from the internal memory, and supplies the additional frames only contained in the online sample zone to the additional-data processor 75.

The content provider may set a plurality of online sample zones, in which case, the sample-zone determining unit 74 is able to randomly select an online sample zone. Instead of presetting an online sample zone by the content provider, the sample-zone determining unit 74 may determine the start position of a sample zone so as to set an online sample zone based on the determined start position.

Regardless of whether a plurality of online sample zones are set or sample zones are randomly set, a total playback time of the sample zones is set so that it is within a predetermined period of time.

The sample band of an online sample zone is set to be wider than that of an offline sample zone, or to be equal to that of the original data. In other words, the online sample zone is the entire band of the content data. That is, the data of the online sample zone can be played back or recorded with higher quality than the sample band of the offline sample zone, or with a quality equivalent to that of the original data.

Upon receiving a request to send online sample data, the additional-data processor 75 receives additional frames corresponding to the online sample zone from the sample-zone determining unit 74. Then, if the sample band of the online sample zone is wider than that of the offline sample zone, and yet, if it is narrower than that of the original data, the additional-data processor 75 restricts the band of the online sample zone by, for example, replacing the normalizing coefficients of predetermined quantizing units by 0. If the sample band of the online sample zone is equivalent to that of the original data, the additional-data processor 75 does not restrict the band of the online sample zone, and adds a header to the corresponding frames so as to generate responding additional data for the online sample data, and outputs it to the additional-data transmitter 76. The header of the responding additional data contains information, such as a content ID, the number of online sample zones, the start position of the online sample zone, the sample zone length, and the sample band.

Upon receiving a request to send high-quality playback data or high-quality recording data (for playing back or recording the original data), the additional-data processor 75 receives additional data consisting of all the additional frames from the sample-zone determining unit 74, and outputs the additional data to the additional-data transmitter 76. The header of the additional data contains information, such as a content ID.

Under the control of the controller 73, the additional-data transmitter 76 sends the additional data or the responding additional data supplied from the additional-data processor 75 to the data playback device 6 or the data recording device 7 that has sent the additional-data request packet.

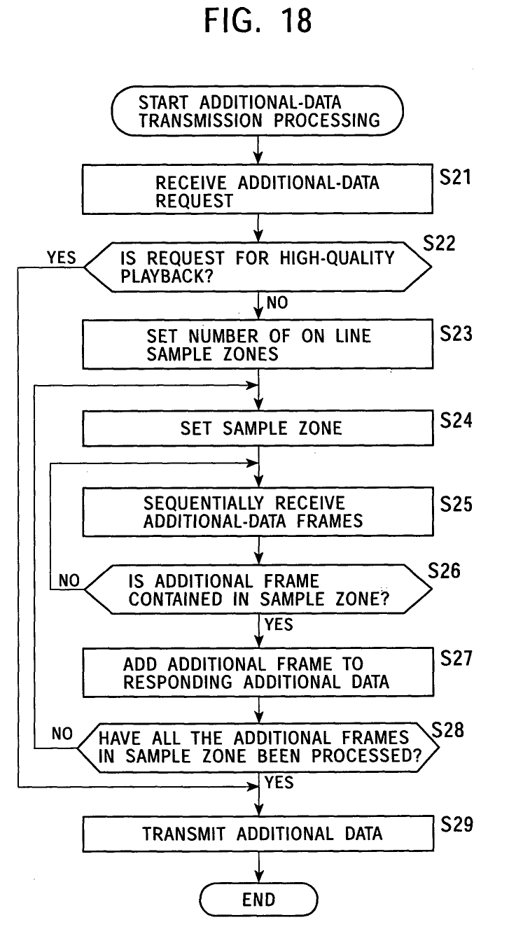

Additional-data transmission processing performed by the additional-data transmitting device 5 is described below with reference to the flowchart of FIG. 18.

In step S21, the additional-data request receiver 72 receives an additional-data request packet from the data playback device 6 or the data recording device 7 via the network 1, and outputs the packet to the additional-data obtaining unit 71 and the controller 73. The controller 73 outputs the content ID of the requested content to the additional-frame obtaining unit 71 based on the additional-data request packet, and controls the additional-frame obtaining unit 71 to obtain the corresponding additional frames.

In step S22, the controller 73 determines whether the additional-data request packet is for obtaining additional data for a high-quality playback or recording operation. If the outcome of step S22 is yes, the process proceeds to step S29. In this case, the controller 73 informs the sample-zone determining unit 74 that additional data for performing a high-quality playback or recording operation is to be sent, and outputs the supplied additional data to the additional-data transmitter 76 via the sample-zone determining unit 74 and the additional-data processor 75.

If it is determined in step S22 that the additional-data request packet is not for obtaining additional data for a high-quality playback or recording operation, it means that the request packet is for obtaining responding additional data for playing back online sample data. Then, the process proceeds to step S23 in which the controller 73 determines the method for setting online sample zones and also sets the number of online sample zones based on an operation input from the user through an operation input unit (not shown), and outputs the corresponding information to the sample-zone determining unit 74.

In step S24, the sample-zone determining unit 74 sets the online sample zones based on the information supplied from the controller 73, i.e., the method for setting the online sample zones and the number of online sample zones. Then, in step S25, the sample-zone determining unit 74 receives additional frames from the additional-frame obtaining unit 71.

In step S26, the sample-zone determining unit 74 determines whether the supplied additional frame is contained in the online sample zone set in step S24. If the outcome of step S26 is no, the sample-zone determining unit 74 discards the supplied additional frame. The process then returns to step S25, and step S25 and the subsequent steps are repeated.

If it is found in step S26 that the supplied additional frame is contained in the online sample zone, the process proceeds to step S27. In step S27, the sample-zone determining unit 74 outputs the supplied additional frame to the additional-frame processor 75 so as to add the additional frame to the responding additional data to be sent. The additional-data processor 75 restricts the band of the supplied additional frame if necessary.

In step S28, the controller 73 determines whether all the additional frames in the sample zone set in step S23 have been processed. If the outcome of step S28 is no, the process returns to step S24, and step S24 and the subsequent steps are repeated.

If it is found in step S28 that all the additional frames in the sample zone have been processed, the additional-frame processor 75 adds a header to the supplied additional frame so as to generate responding additional data, and supplies it to the additional-data transmitter 76. Then, if it is determined in step S28 that all the additional frames in the sample zone have been processed, or if it is determined in step S22 that the additional-data request packet is for obtaining additional data for a high-quality playback or recording operation, the process proceeds to step S29. In step S29, the additional-data transmitter 76 sends via the network 1 the additional data or the responding additional data supplied from the additional-data processor 75 to the data playback device 6 or the data recording device 7 that has sent the additional-data request packet. The process is then completed.

According to the processing shown in FIG. 18, responding additional data is generated, and the additional data or the responding additional data is sent to the data playback device 6 or the data recording device 7 that has sent an additional-data request packet. The client 3-1 provided with the data playback device 6 or the client 3-2 provided with the data recording device 7 receives offline sample data, which is sent via the network 1 or is recorded in a recording medium, such as a magneto-optical disk, by using, for example, MMK. Accordingly, the data playback device 6 is able to reconstruct high-quality data or online sample data and plays it back by using the offline sample data and the additional data or the responding additional data supplied from the additional-data transmitting device 5. The data recording device 7 is able to reconstruct the high-quality data and record it by using the offline sample data and the additional data sent from the additional-data transmitting device 5.

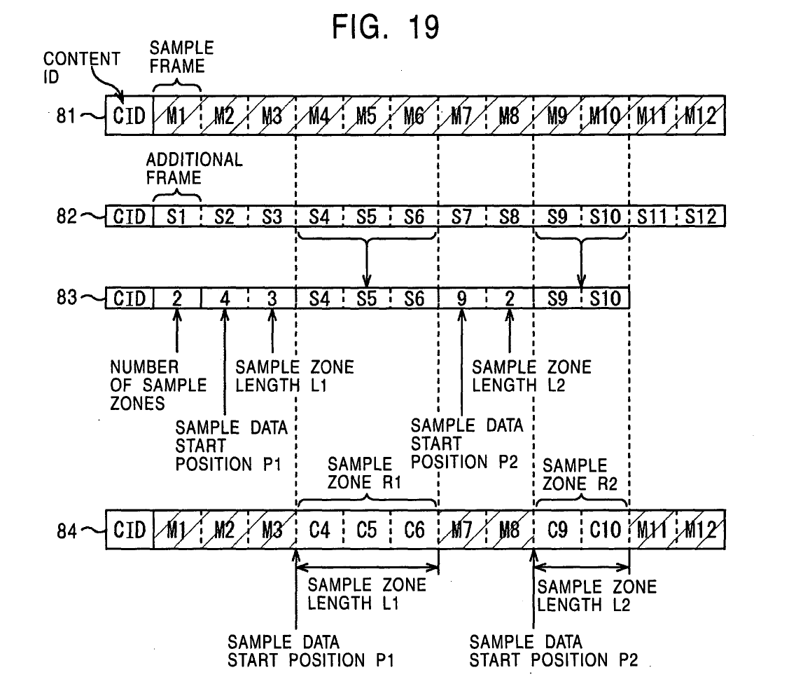

It is now assumed, for example, as shown in FIG. 19, that the data playback device 6, which possesses sample data 81 consisting of sample frames M1 through M12, requests the additional-data transmitting device 5 to send responding additional data by sending an additional-data request packet containing a content ID indicated in the header of the sample data 81. Then, the additional-frame obtaining unit 71 of the additional-data transmitting device 5 receives additional data 82 consisting of additional frames S1 through S12 associated with the sample data 81, and supplies the additional data 82 to the sample-zone determining unit 74.

The sample-zone determining unit 74 determines the sample zones, and generates responding additional data 83 based on the supplied additional data 82 according to the determined sample zones. The header of the responding additional data 83 contains a content ID and the number of sample zones, and also contains the sample-zone start position and the sample zone length at the head of frames to be added in each online sample zone. Then, additional frames in the online sample zones are inserted. The responding additional data 83 is sent to the data playback device 6 that has sent the additional-data request packet.

In this example, two sample zones (R1 and R2) are set. The start position P1 of the first sample zone R1 is set to be the fourth frame, and the sample zone length L1 is set to be three frames. The start position P2 of the second sample zone R2 is set to be the ninth frame, and the sample zone length L2 is set to be two frames. Accordingly, if the sample band of the online sample zones is the same as that of the original data, the additional frames contained in the responding additional frame 83 are S4, S5, S6, S9, and S10.

Then, the data playback device 6 that receives the responding additional data 83 generates sample playback data 84 by using the sample data 81 and the responding additional data 83 according to processing, which is described below. In the sample playback data 84, the frames C4, C5, C6, C9, and C10, which are reconstructed into high quality data by responding additional data 83, are contained in the sample zones R1 and R2, and sample frames are contained in the other zones.

It is now assumed that the sample band of the sample data 81 is set to be 0, and that the sample band of the online sample data is the entire band of the original data. In this case, when playing back the sample playback data 84, only the frames C4, C5, C6, C9, and C10 in the online sample zones R1 and R2 that are reconstructed into high quality data are played back with a high quality equivalent to that of the original data, and sample frames M1, M2, M3, M7, M8, M11, and M12 outside the online sample zones are not played back.

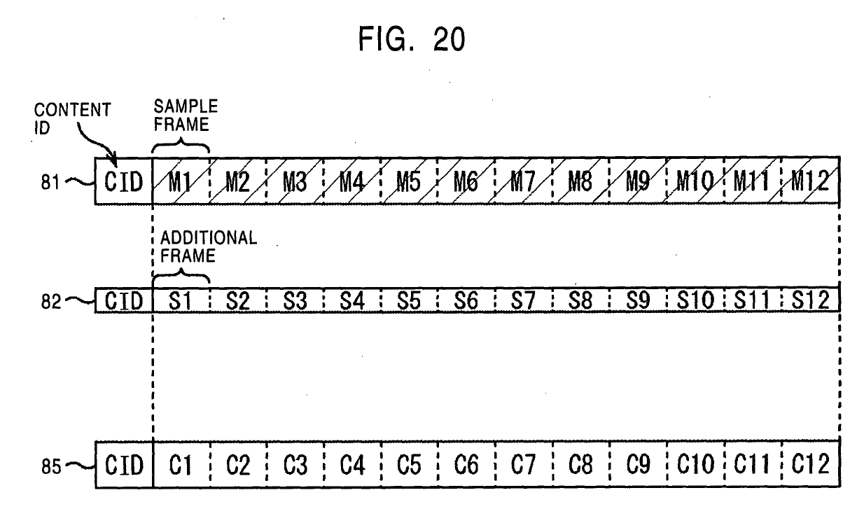

It is now assumed, for example, as shown in FIG. 20, that the data playback device 6 or the data recording device 7, which possesses the sample data 81 consisting of sample frames M1 through M12, requests the additional-data transmitting device 5 to send the additional data 82 by sending an additional-data request packet containing a content ID indicated in the header of the sample data 81. Then, the additional-frame obtaining unit 71 of the additional-data transmitting device 5 receives the additional data 82 consisting of additional frames S1 through S12 associated with the sample data 81. The additional data 82 is then sent to the data playback device 6 or the data recording device 7 that has sent the additional-data request packet via the sample-zone determining unit 74, the additional-data processor 75, and the additional-data transmitter 76.

Then, the data playback device 6 or the data recording device 7 that has received the additional data 82 generates high-quality playback data 85 by using the sample data 81 and the additional data 82 according to processing, which is described below. If the sample band of the online sample data is set to be the entire band of the original data, the high-quality playback data 85 consists of frames C1 through C12 that are constructed into high-quality data, as in the frames generated in the sample zones R1 and R2 of the sample playback data 84 shown in FIG. 19.

A description is now given of processing for generating online sample data from sample data and responding additional data, and decoding and outputting or playing back the generated online sample data, or processing for generating original data from sample data and additional data and for decoding and outputting or playing back the generated original data.

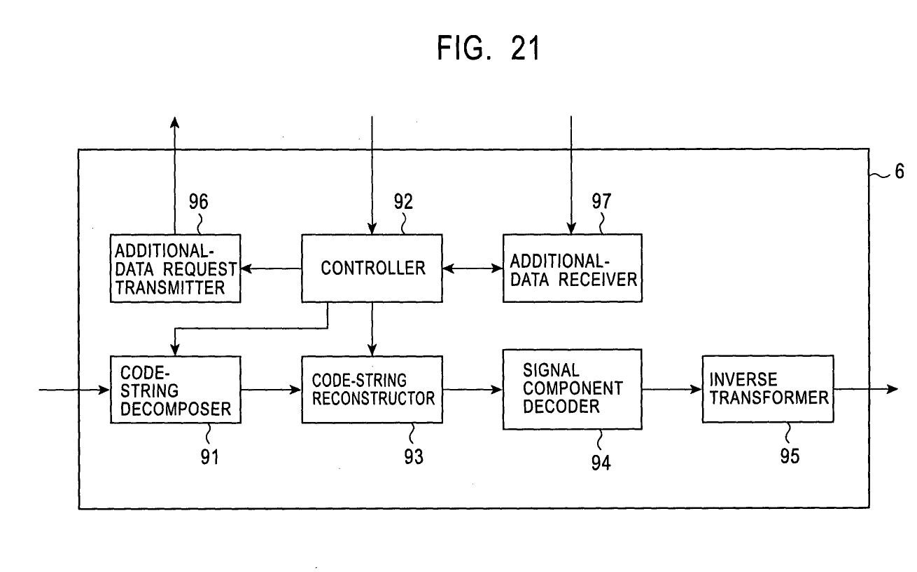

FIG. 21 is a block diagram illustrating the configuration of the data playback device 6.

According to a control signal supplied from a controller 92, a code-string decomposer 91 receives sample data (which is generated by the coding device 4 and is possessed in the client 3-1) corresponding to the content designated by a predetermined content ID. The code-string decomposer 91 then decomposes the code string so as to extract signal component codes, and outputs them to a code-string reconstructor 93.

The controller 92 receives an operation, indicating the type of playback operation for the input data (whether a high-quality playback operation, an offline sample-data playback operation, or an online sample-data playback operation is performed), input from a user through an operation input unit (not shown). Then, the controller 92 generates a control signal for controlling an additional-data request transmitter 96 to send a request for additional data or responding additional data, and outputs the control signal to the additional-data request transmitter 96. The controller 92 also receives additional data from an additional-data receiver 97, and, if necessary, supplies information, for example, normalizing-coefficient information or true values of spectrum-coefficient information, contained in the additional data or the responding additional data to the code-string reconstructor 93, and also controls the processing of the code-string reconstructor 93.

Under the control of the controller 92, the additional-data request transmitter 96 generates an additional-data request packet for requesting additional data or responding additional data, and sends the request packet to the additional-data transmitting device 5 of the server 2 via the network 1.

The additional-data receiver 97 receives additional data (for example, the additional data 82 shown in FIGS. 19 and 20) or responding additional data (for example, the responding additional data 83 shown in FIG. 19) sent from the additional-data transmitting device 5 via the network 1, and supplies the received data to the controller 92.

If the input sample data is to be played back in the offline sample zones, the code-string reconstructor 93 directly outputs the input coded frames to a signal component decoder 94 under the control of the controller 92. If online sample data is generated from the input sample data, or if original data is reconstructed from the input sample data, the code-string reconstructor 93 reconstructs the coded frames of the sample data based on various information, such as normalizing-coefficient information or the true values of spectrum-coefficient information, contained in the additional frames or the responding additional frames supplied from the controller 92. The code-string reconstructor 93 then outputs the reconstructed coded frames to the signal component decoder 94.

If the online sample data is played back, the code-string reconstructor 93 may reconstruct the frames only in online sample zones, and supplies them to the signal component decoder 94.

The signal component decoder 94 decodes the coded frames of the input offline sample data, online sample data, or original data.

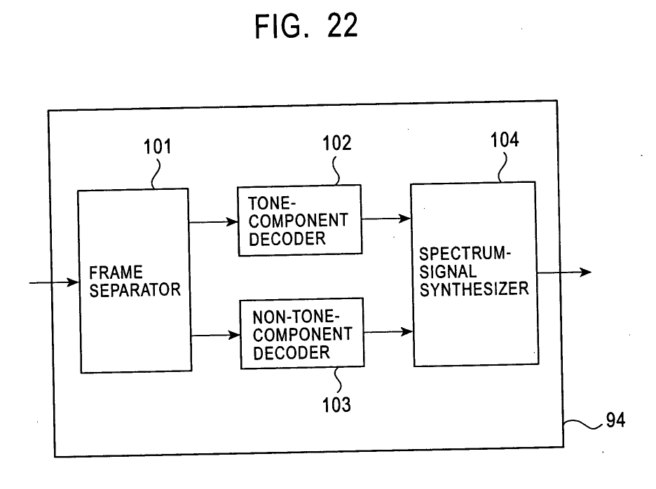

The signal component decoder 94 decodes the coded frames of the input offline sample data, online sample data, or original data. FIG. 22 is a block diagram illustrating the detailed configuration of the signal component decoder 94 for decoding input coded frames into tone components and non-tone components when the coded frames are coded by being separated into tone components and non-tone components.

A frame separator 101 receives a coded frame, such as that shown in FIG. 11, and separates it into tone components and non-tone components. The tone components are output to a tone-component decoder 102, and the non-tone components are output to a non-tone-component decoder 103.

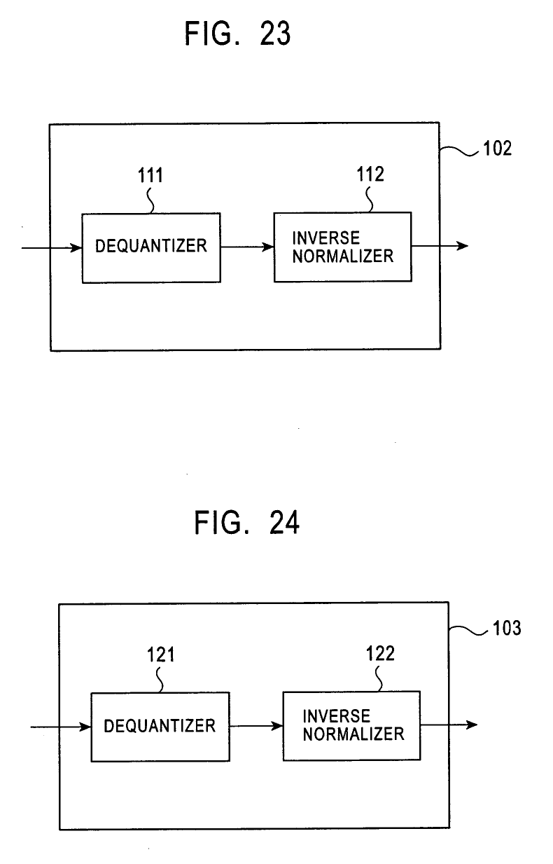

FIG. 23 is a block diagram illustrating the detailed configuration of the tone-component decoder 102. A dequantizer 111 dequantizes input coded data and outputs the dequantized data to an inverse normalizer 112. The inverse normalizer 112 inverse-normalizes the input data. That is, decoding processing is performed by the dequantizer 111 and the inverse normalizer 112 so as to output a spectrum signal of the tone components.

FIG. 24 is a block diagram illustrating the detailed configuration of the non-tone-component decoder 103. A dequantizer 121 dequantizes input coded data and outputs the dequantized data to an inverse normalizer 122. The inverse normalizer 122 inverse-normalizes the input data. That is, decoding processing is performed by the dequantizer 121 and the inverse normalizer 122 so as to output a spectrum signal of the non-tone components.

A spectrum-signal synthesizer 104 receives the spectrum signal components output from the tone-component decoder 102 and the non-tone component decoder 103, and combines the spectrum signal components. The spectrum-signal synthesizer 104 generates the spectrum signal shown in FIG. 6 for the original data, and then outputs the spectrum signal to an inverse transformer 95.

If the coded data is coded without being divided into tone components and non-tone components, the frame separator 101 and the spectrum-signal synthesizer 104 can be omitted, and decoding processing is performed by using one of the tone-component decoder 102 and the non-tone-component decoder 103.

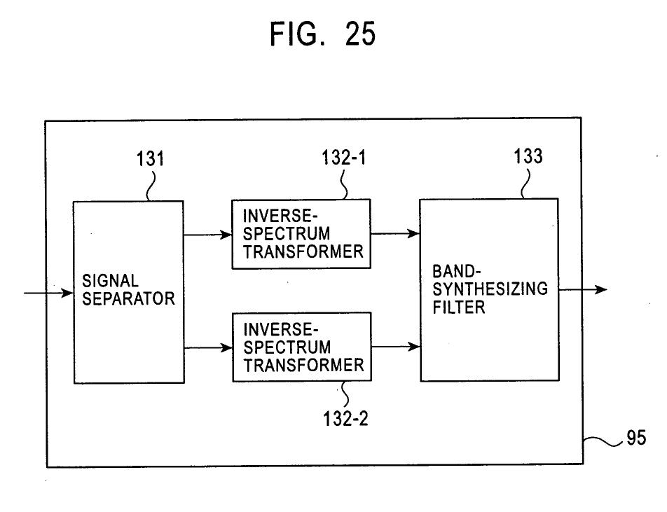

FIG. 25 is a block diagram illustrating the detailed configuration of the inverse transformer 95.

A signal separator 131 separates a signal based on the number of divided bands indicated in the header of an input frame. In this case, the number of divided bands is two, and the signal separator 131 separates the input spectrum signal into two bands, and outputs them to inverse-spectrum transformers 132-1 and 132-2.

The inverse-spectrum transformers 132-1 and 132-2 perform inverse-spectrum transform on the input spectrum signal components, and outputs the transformed signal components in the corresponding bands to a band-synthesizing filter 133. The band-synthesizing filter 133 combines the input signal components, and outputs the resulting synthesized signal.

The signal (for example, an audio PCM signal) output from the band-synthesizing filter 133 is converted into analog data by a digital-to-analog (D/A) converter (not shown), and may be output from a speaker (not shown) as sound. The signal output from the band-synthesizing filter 133 may be output to another device via a network.

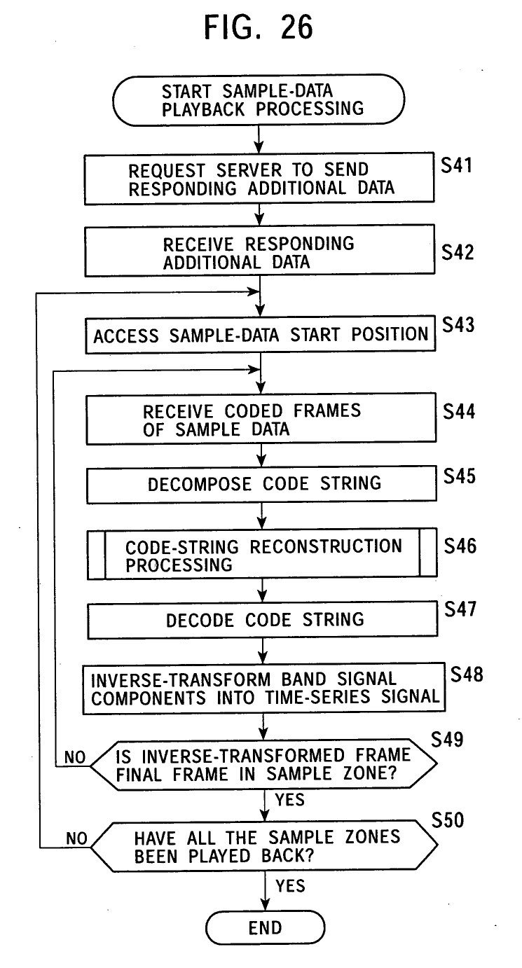

Online-sample-data playback processing performed by the data playback device 6 shown in FIG. 21 is described below with reference to the flowchart of FIG. 26.

In step S41, the controller 92 receives an operation, indicating a request to play back online sample data of content designated by a content ID, input from an operation input unit (not shown), generates a control signal for requesting the additional-data transmitting device 5 to send responding additional data, and outputs the control signal to the additional-data request transmitter 96. Under the control of the controller 92, the additional-data request transmitter 96 then generates an additional-data request packet for requesting the responding additional data designated by the content ID, and sends the request packet to the additional-data transmitting device 5 via the network 1.

If the sample data of the content designated by the content ID is not recorded, the controller 92 may control the client 3-1 to receive the sample data of the content designated by the content ID from the coding device 4 via the network 1.

In step S42, the additional-data receiver 97 receives the responding additional data sent from the additional-data transmitting device 5 via the network 1. As in the responding additional data 83 shown in FIG. 19, the received responding additional data contains information, such as the content ID and the number of sample zones, and also contains information, such as the start position, the sample zone length of each sample zone, and data of additional frames in the online sample zones.

In step S43, under the control of the controller 92, the code-string decomposer 91 accesses the start position of the first sample data corresponding to the content designated by the content ID indicated in the responding additional data 83, and reads the number of sample frames based on the sample zone length. In step S44, the code-string decomposer 91 receives the sample frames of the read sample data. Then, in step S45, the code-string decomposer 91 decomposes the input code string and outputs the codes to the code-string reconstructor 93.

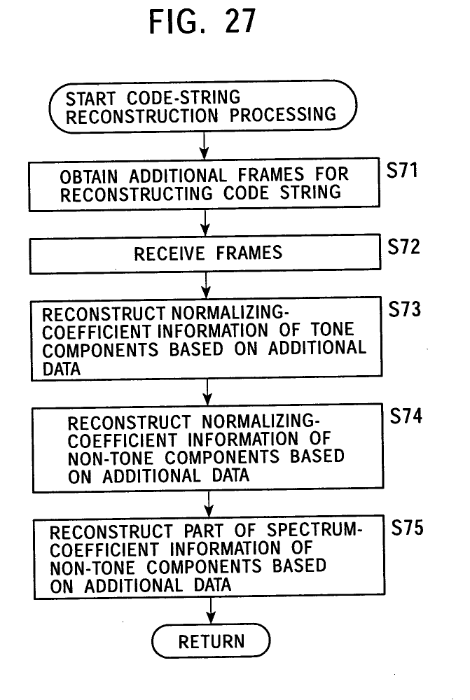

In step S46, code-string reconstruction processing, which is described below with reference to the flowchart of FIG. 27, is performed, and the frames in the online sample zones are reconstructed.

In step S47, the signal component decoder 94 divides the input code string into tone components and non-tone components, and decodes them by dequantizing and inverse-transforming them so as to generate spectrum signal components. The signal component decoder 94 then combines the generated spectrum signal components and outputs the synthesized spectrum signal to the inverse transformer 95.

In step S48, the inverse transformer 95 separates the input spectrum signal into bands if necessary, and inverse-spectrum transforms the separated signal components. The transformed signal components are then combined, and the combined signal is inverse-transformed into a time-series signal.

In step S49, the controller 92 determines whether the frame inverse-transformed by the inverse transformer 95 in step S48 is the final frame.

If it is found in step S49 that the frame is not the final frame, the process returns to step S44, and step S44 and the subsequent steps are repeated. If it is found in step S49 that the frame is the final frame, the controller 92 determines in step S50 whether all the sample zones have been played back.

If the outcome of step S50 is no, the process returns to step S43 in which the code-string decomposer 91 accesses the start position of the subsequent sample zone, and the subsequent steps are repeated. If it is determined in step S50 that all the samples zones have been played back, the processing is completed.

The time-series signal generated by being inverse-transformed by the inverse transformer 95 is converted into analog data by a D/A converter (not shown), and may be output from a speaker (not shown). Alternatively, the signal may be output to another device via a network (not shown).

If a plurality of sample zones are played back in the online-sample-data playback operation, fade-in or fade-out processing may be performed at the interfaces of the zones so as to prevent unnatural, discontinuous playback operation at the interfaces.

In this example, it is assumed that the sample data is coded by being separated into tone components and non-tone components. However, if the sample data is not separated into tone components and non-tone components, reconstruction processing and playback processing similar to those described above can also be performed.

Details of the code-string reconstruction processing performed in step S46 of FIG. 26 are described below with reference to the flowchart of FIG. 27.

In step S71, the code-string reconstructor 93 obtains additional frames contained in the additional data or the responding additional data from the controller 92 so as to reconstruct the code string. In the additional frames, data (for example, the true values of normalizing-coefficient information and the true values of spectrum-coefficient information) for reconstructing the sample frames are indicated.

In step S72, the code-string reconstructor 93 receives the frames decomposed by the code-string decomposer 91. Then, in step S73, the code-string reconstructor 93 reconstructs the normalizing-coefficient information of the tone components, which is replaced by 0 in the sample frames of the sample data, by using the true values of the normalizing-coefficient information of the tone components contained in the additional frame shown in FIG. 12.

In step S74, the code-string reconstructor 93 reconstructs the normalizing-coefficient information of the non-tone components, which is replaced by 0 in the sample frames of the sample data, by using the true values of the normalizing-coefficient information of the non-tone components contained in the additional frame shown in FIG. 12.

In step S75, the code-string reconstructor 93 reconstructs the spectrum-coefficient information of the non-tone components, which is replaced by 0, by using the true values of the spectrum-coefficient information of the non-tone components contained in the additional frame shown in FIG. 12. The process then returns to step S47 of FIG. 26.

According to the processing described with reference to FIGS. 26 and 27, sample data frames in the sample zones can be generated by using sample data and responding additional data.

In the processing shown in FIGS. 26 and 27, the original data is reconstructed by using the additional data shown in FIG. 12, assuming that all the true values of the normalizing-coefficient information are indicated in the additional data. If, however, part of or all the true values of the normalizing-coefficient information are indicated in a space of a sample frame, the code-string reconstructor 93 reconstructs the normalizing-coefficient information replaced by 0 by using the true values of the normalizing-coefficient information indicated in the space in the sample frame.

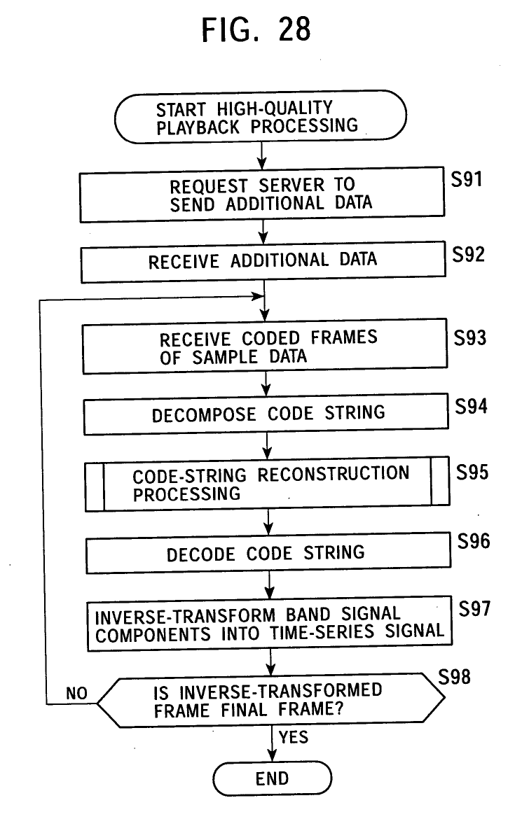

High-quality playback processing performed by the data playback device 6 shown in FIG. 21 is described below with reference to the flowchart of FIG. 28.

In step S91, the controller 92 receives an operation, indicating a request to perform a high-quality playback operation on the content designated by a content ID, from an operation input unit (not shown). The controller 92 then generates a control signal to control the additional-data request transmitter 96 to send a request for additional data, and outputs the control signal to the additional-data request transmitter 96. Under the control of the controller 92, the additional-data request transmitter 96 generates an additional-data request packet to request the server 2 to send additional data designated by the content ID, and sends the request packet to the additional-data transmitting device 5 of the server 2 via the network 1.

In step S92, the additional-data receiver 97 receives the additional data sent from the additional-data transmitting device 5 via the network 1. The received additional data contains all the additional frames, such as in the additional data 82 shown in FIG. 20.

Steps S93 through S97 are basically similar to steps S44 through S48, respectively, of FIG. 26. More specifically, the code-string decomposer 91 receives the sample frames of the sample data, decomposes the input code string, and outputs it to the code-string reconstructor 93. Then, the code-string reconstruction processing shown in FIG. 27 is performed. Since all the additional frames are used in the code-string reconstruction processing, the original data can be reconstructed.

In step S98, the controller 92 determines whether the frame inverse-transformed by the inverse transformer 95 in step S97 is the final frame.

If it is determined in step S98 that the frame is not the final frame, the process returns to step S93, and step S93 and the subsequent steps are repeated. If it is determined in step S98 that the frame is the final frame, the processing is completed.

The original data reconstructed and decoded by the processing described with reference to FIG. 28 may be output via a speaker (not shown), or may be output to another device via, for example, a network.

A description is now given of processing for recording sample data in a recording medium or for reconstructing original data from sample data and additional data and recording the reconstructed original data in a recording medium.

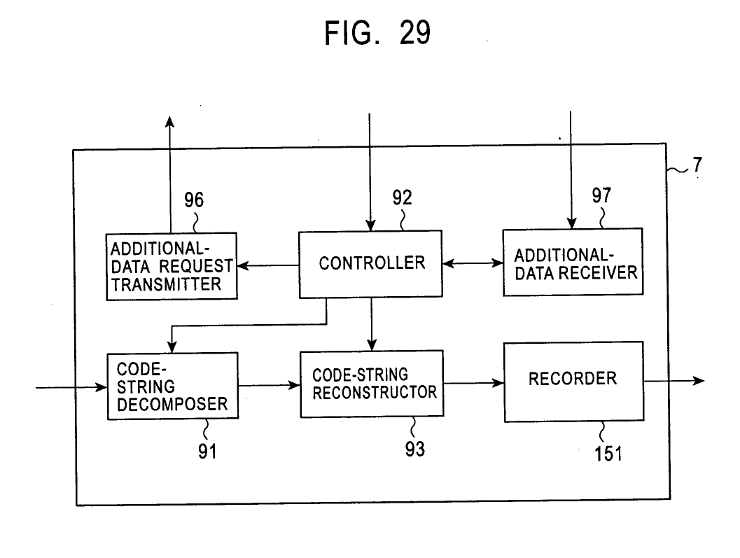

FIG. 29 is a block diagram illustrating the configuration of the data recording device 7.

In FIG. 29, elements corresponding to those of the data playback device 6 shown in FIG. 21 are indicated by like reference numerals, and an explanation thereof is thus omitted.

A code-string decomposer 91 receives coded sample data and decomposes a code string so as to extract signal component codes. A controller 92 receives an operation from a user through an operation input unit (not shown) and determines whether the input sample data is to be recorded with high quality or as offline sample data, i.e., whether the original data is to be reconstructed and recorded. The controller 92 then controls an additional-data request transmitter 96 to send an additional-data request packet, receives additional data from the additional-data receiver 97, and controls the processing of the code-string reconstructor 93.

When recording the input sample data as offline sample data, the code-string reconstructor 93 directly outputs the input sample frames to a recorder 151 under the control of the controller 92. When reconstructing and recording the original data with high quality, the code-string reconstructor 93 reconstructs, under the control of the controller 92, the coded frames of the original data from the input sample data by using various information, such as the true values of normalizing-coefficient information and the true values of spectrum-coefficient information, supplied from the controller 92, and outputs the reconstructed coded frames of the original data to the recorder 151.

The recorder 151 records the data in a recording medium, for example, a magnetic disk, an optical disc, a magneto-optical disk, a semiconductor memory, or magnetic tape, according to a predetermined method. The recorder 151 may be a storage unit, such as a memory or a hard disk, provided for a substrate. For example, if the recorder 151 is able to record data in an optical disc, the recorder 151 is formed of an encoder for converting data into a format that is suitable for being recorded in an optical disc, an optical unit including a laser light source, such as a laser diode, various lenses, and a deflection beam splitter, a spindle motor for driving an optical disc, a driver for driving the optical unit to a predetermined track position of an optical disc, and a controller for controlling all the elements.

A recording medium loaded in the recorder 151 may be the same as the recording medium in which the sample data or the additional data input into the code-string decomposer 91 or into the controller 92 is recorded.

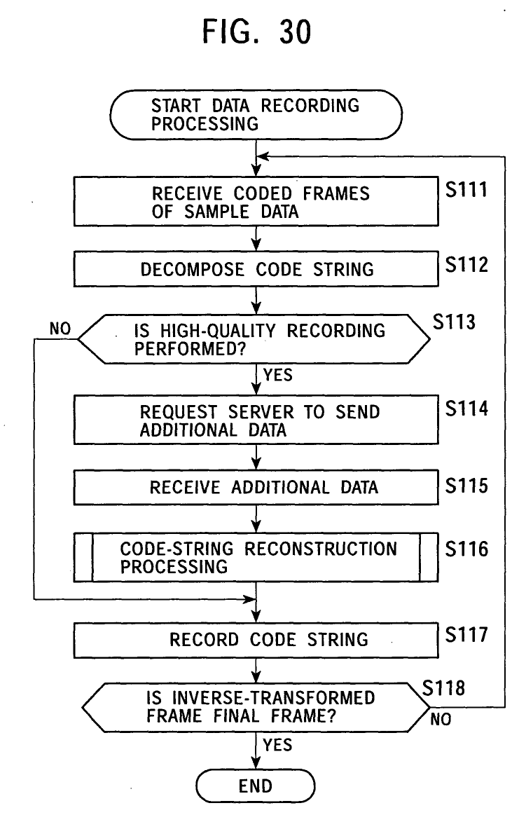

Data recording processing performed by the data recording device 7 is described below with reference to the flowchart of FIG. 30.

In step S111, the code-string decomposer 91 receives coded frames of sample data. In step S112, the code-string decomposer 91 decomposes the input code string, and outputs the decomposed codes to the code-string reconstructor 93.

In step S113, the code-string reconstructor 93 determines whether high-quality recording is performed based on the signal input from the controller 92. If the outcome of step S113 is yes, processing similar to steps S91 and S92 of FIG. 28 is performed in steps S114 and S115. That is, the controller 92 generates a control signal for requesting the server 2 to send additional data, and outputs the control signal to additional-data request transmitter 96. The additional-data request transmitter 96 generates an additional-data request packet, and outputs it to the additional-data transmitting device 5 of the server 2 via the network 1. The additional-data receiver 97 then receives the additional data sent from the additional-data transmitting device 5 via the network 1. The received additional data contains all the additional frames, such as in the additional data 82 shown in FIG. 20.

In step S116, the code-string reconstruction processing shown in FIG. 27 is performed.

If it is determined in step S113 that high-quality recording is not performed, or after step S116, the process proceeds to step S117. In step S117, the recorder 151 records the code string corresponding to the input original data or offline sample data in a recording medium loaded in the data recording device 7.

In step S118, the controller 92 determines whether the frame recorded by the recorder 151 in step S117 is the final frame of the code string corresponding to the original data or the offline sample data.

If it is found in step S118 that the frame is not the final frame, the process returns to step S111, and step S111 and the subsequent processing is performed. If it is found in step S118 that the frame is the final frame, the processing is completed.

In the processing indicated by the flowchart of FIG. 30, online sample data whose quality of the sample zones is increased by using the responding additional data cannot be recorded. However, for example, an online sample zone may be preset for each item of content, and the data recording device 7 may request the additional-data transmitting device 5 to send responding additional data. Then, it is possible to reconstruct and record the online sample data according to processing similar to the sample-data playback processing shown in FIG. 26.

By the application of the present invention, when playing back or recording offline sample data, the values of normalizing-coefficient information outside the playback zone are changed to, for example, 0, and also, data which is not referred to since the corresponding normalizing-coefficient information is changed, the corresponding values of spectrum-coefficient information are replaced by dummy data. Sample data can thus be generated. It is very difficult to predict the original data from such sample data. In particular, by setting the offline sample zone to be a narrow band or 0, it is even more difficult to predict the original data from the sample data. Also, illegal falsification of the sample data results in a deterioration in the audio quality. It is thus possible to protect the copyright of content and the right of a content distributor.

Alternatively, the frames that cannot be previewed or listened to when offline sample data is played back can be prevented from being played back by separating all the values of normalizing-coefficient information or separating the normalizing-coefficient information of each frame.

When playing back online sample data by using the sample data, only the additional data in the sample zones set by the additional-data transmitting device 5 is sent to the data playback device 6 of the client 3-1 possessed by a content user. Accordingly, the administrator of the additional-data transmitting device 5 is able to restrict the playback time or the playback position of the sample data, thereby enabling the user to preview or listen to the sample data with higher quality than the offline sample data.

When generating offline sample data, additional data consisting of additional frames containing true values, for example, the true values of normalizing-coefficient information or the true values of spectrum-coefficient information, replaced by dummy data is generated. It is thus possible to reconstruct the original data from the offline sample data by using the additional data.

If part of or the entirety of the information to be indicated in the additional frames is contained in a space of an offline sample frame, the amount of the additional data or the responding additional data can be reduced, thereby decreasing the time for the user to download the additional data or the responding additional data.

The above-described processing has been described, assuming that the server 2 is provided with the coding device 4 and the additional-data transmitting device 5. However, the processing performed by the coding device 4 and the processing performed by the additional-data transmitting device 5 may be performed in the same device. Alternatively, the coding device 4 and the additional-data transmitting device 5 may be provided for different servers.

By applying the present invention, offline sample data, online sample data, or reconstructed original data can be played back and output, or can be recorded in a recording medium, or output to another device via, for example, a network.

In the above-described embodiment, offline sample data and corresponding additional data are generated from audio-signal content data, and online sample data is generated from offline sample data and responding additional data, and is played back or recorded. Audio-signal original data is reconstructed from offline sample data and additional data, and is played back or recorded. In the present invention, content data may include image signals or image signals and audio signals.

For example, content data in the form of image signals is transformed by using two-dimensional DCT and is quantized by using various quantizing tables. In this case, sample data is generated by designating a dummy quantizing table in which high-band components are missing and by recording dummy data in the spectrum-coefficient information of the high-band components. In additional data, the missing high-band components of the dummy quantizing table and the spectrum-coefficient information replaced by dummy data are indicated.

When reconstructing the original data, the true quantizing table in which high-band components are not missing is reconstructed by using the additional data, and the true values of the spectrum-coefficient information are also reconstructed. As a result, the original data can be reconstructed and decoded.

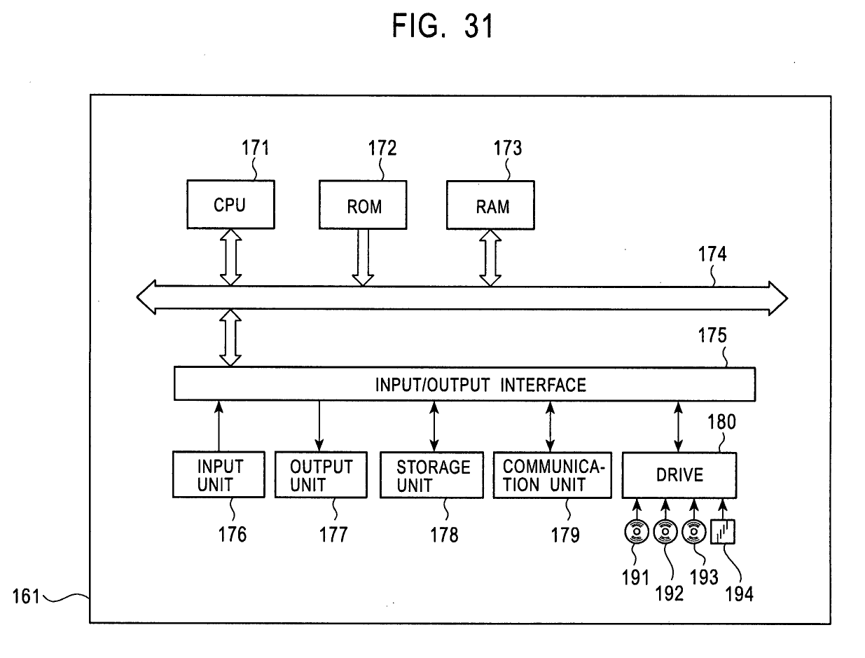

The above-described series of processing may be executed by hardware or software. If software is used, the coding device 4, the data playback device 6, or the data recording device 7 may be formed of a personal computer 161 shown in FIG. 31.

In FIG. 31, a central processing unit (CPU) 171 executes various types of processing according to a program stored in a read only memory (ROM) 172 or a program loaded into a random access memory (RAM) 173. The RAM 173 also stores data required for executing various types of processing by the CPU 171.

The CPU 171, the ROM 172, and the RAM 173 are connected to each other via a bus 174. An input/output interface 175 is also connected to the bus 174.

The input/output interface 175 is also connected to an input unit 176 including, for example, a keyboard and a mouse, an output unit 177 including, for example, a display device and a speaker, a storage unit 178 formed of, for example, a hard disk, and a communication unit 179 including, for example, a modem and a terminal adapter. The communication unit 179 performs communication processing via a network including the Internet.

The input/output interface 175 is also connected to a drive 180. A recording medium, such as a magnetic disk 191, an optical disc 192, a magneto-optical disk 193, or a semiconductor memory 194, is loaded in the drive 180, and a computer program read from such a recording medium is installed into the storage unit 178.

If the above-described series of processing is executed by software, the software programs is installed via a network or a recording medium into a computer integrated in dedicated hardware, or into a computer, for example, a general-purpose personal computer, that is able to execute various functions by installing various programs.

Such a recording medium includes package media, such as the magnetic disk 191 (including floppy disks), the optical disc 192 (including compact disc read only memory (CD-ROM) and digital versatile disk (DVD)), the magneto-optical disk 193 (including mini disk (MD) (trademark)), and the semiconductor memory 194, which are distributed for supplying the programs to users. The recording medium also includes the ROM 172 and a hard disk contained in the storage unit 178 storing the programs therein, which are supplied to users while being integrated into the device.

In this specification, steps forming the programs stored in a recording medium include not only processing executed in chronological order, but also processing executed concurrently or individually.

What is claimed is:

1. An information processing method for an information processing apparatus for distributing a third data string to a first information processing apparatus which generates a fourth data string by using a second data string generated based on a first data string and by using the third data string and which plays back or records the generated fourth data string, said information processing method comprising:
an acquisition control step of controlling the acquisition of a fifth data string containing first data required for reconstructing the second data string into the first data string;
a zone determining step of determining at least one zone of the fourth data string to be played back or recorded by said first information processing apparatus; and
a first generating step of generating the third data string to be distributed to said first information processing apparatus from the fifth data string controlled to be acquired in said acquisition control step based on said at least one zone determined in said zone determining step.

2. An information processing method according to claim 1, wherein, in said zone determining step, a plurality of data zone candidates are prepared, and at least one of the data zone candidates is selected from the plurality of data zone candidates, thereby determining said at least one zone.

3. An information processing method according to claim 1, wherein, in said zone determining step, said at least one zone is determined randomly.

4. An information processing method according to claim 1, wherein, in said zone determining step, said at least one zone is determined so that a total playback time or a total recording time of the fourth data string in said at least one zone is within a predetermined period of time.

5. An information processing method according to claim 1, wherein, in said first generating step, the third data string including information indicating a playback start position or a recording start position of the fourth data string defined by said at least one zone is generated.

6. An information processing method according to claim 1, wherein, in said first generating step, the third data string including information indicating a playback data zone or a recording data zone of the fourth data string defined by said at least one zone is generated.

7. An information processing method according to claim 1, further comprising a band determining step of determining a frequency band of the fourth data string to be played back or recorded by said first information processing apparatus, wherein, in said first generating step, the third data string that allows the fourth data string to be played back or recorded within the frequency band determined in said band determining step is generated.

8. An information processing method according to claim 1, wherein the first data includes data separated from the first data string when the second data string is generated from the first data string, or includes data replaced by second data which is different from the first data.

9. An information processing method according to claim 1, further comprising:
a replacement step of replacing the first data contained in the first data string by second data which is different from the first data;
a second generating step of generating the second data string by using data generated in said replacement step; and
a third generating step of generating the fifth data string containing the first data.

10. An information processing method according to claim 9, wherein, in said replacement step, the first data contained in the first data string is replaced by the second data so that the playback quality of the second data string becomes lower than the playback quality of the first data string.

11. An information processing method according to claim 9, wherein the second data is data in which at least part of the first data is replaced by random data.

12. An information processing method according to claim 9, further comprising a coding step of coding input data, wherein, in said replacement step, the first data contained in the first data string is replaced by the second data by using the data coded in said coding step as the first data string.

13. An information processing method according to claim 12, wherein the first data contains normalizing-coefficient information used for coding processing in said coding step.

14. An information processing method according to claim 12, wherein the first data contains quantizing-precision information used for coding processing in said coding step.

15. An information processing method according to claim 12, wherein the first data contains variable-length codes.

16. An information processing method according to claim 12, further comprising a transform step of transforming frequency components, wherein, in said coding step, data transformed in said transform step is coded, and the first data contains spectrum-coefficient information.

17. An information processing method according to claim 1, further comprising a reception control step of controlling a signal to be received from said first information processing apparatus, the signal indicating a request for the third data string designating the playback quality or the recording quality of the fourth data string, wherein, in said first generating step, the third data string that allows the fourth data string to be played back or recorded with the playback quality or the recording quality designated by the signal is generated.

18. An information processing apparatus for distributing a third data string to a first information processing apparatus which generates a fourth data string by using a second data string generated based on a first data string and by using the third data string and which plays back or records the generated fourth data string, said information processing apparatus comprising:
acquisition means for acquiring a fifth data string containing data required for reconstructing the second data string into the first data string;
zone determining means for determining at least one zone of the fourth data string to be played back or recorded by said first information processing apparatus; and
generating means for generating the third data string to be distributed to said first information processing apparatus from the fifth data string acquired by said acquisition means based on said at least one zone determined by said zone determining means.

19. A recording medium recording therein a computer-readable program for an information processing apparatus that distributes a third data string to a first information processing apparatus which generates a fourth data string by using a second data string generated based on a first data string and by using the third data string and which plays back or records the generated fourth data string, said computer-readable program comprising:
an acquisition control step of controlling the acquisition of a fifth data string containing data required for reconstructing the second data string into the first data string;
a zone determining step of determining at least one zone of the fourth data string to be played back or recorded by said first information processing apparatus; and
a generating step of generating the third data string to be distributed to said first information processing apparatus from the fifth data string controlled to be acquired in said acquisition control step based on said at least one zone determined in said zone determining step.

20. A computer-executable program for controlling an information processing apparatus for distributing a third data string to a first information processing apparatus which generates a fourth data string by using a second data string generated based on a first data string and by using the third data string and which plays back or records the generated fourth data string, said computer-executable program comprising:
an acquisition control step of controlling the acquisition of a fifth data string containing data required for reconstructing the second data string into the first data string;
a zone determining step of determining at least one zone of the fourth data string to be played back or recorded by said first information processing apparatus; and
a generating step of generating the third data string to be distributed to said first information processing apparatus from the fifth data string controlled to be acquired in said acquisition control step based on said at least one zone determined in said zone determining step.

21. An information processing method for an information processing apparatus for generating a fourth data string by using a second data string generated from a first data string and by using a third data string received from a first information processing apparatus, said information processing method comprising:
a reception control step of controlling the third data string to be received from said first information processing apparatus;
a replacement step of replacing first data contained in the third data string controlled to be received in said reception control step by second data contained in the second data string; and
a generating step of generating the fourth data string to be played back or recorded in at least one zone by using data generated in said replacement step.

22. An information processing method according to claim 21, wherein the third data string includes information indicating a playback start position or a recording start position of the fourth data string.

23. An information processing method according to claim 21, wherein the third data string includes information indicating said at least one zone when the fourth data string is played back or recorded.

24. An information processing method according to claim 21, wherein the fourth data string is played back or recorded in said at least one zone with a quality equivalent to the first data string.

25. An information processing method according to claim 21, wherein the fourth data string is played back or recorded in said at least one zone with an audio band narrower than the first data string and broader than the second data string.

26. An information processing method according to claim 21, wherein, in said replacement step, the first data is replaced by the second data so that the playback quality or the recording quality of the fourth data string becomes higher than the playback quality or the recording quality of the second data string.

27. An information processing method according to claim 21, further comprising a decoding step of decoding the second data string, wherein:
in said replacement step, the second data contained in the second data string is replaced by the first data; and
in said decoding step, the fourth data string generated in said generating step is decoded.

28. An information processing method according to claim 27, wherein the second data string is a coded data string, and the first data contained in the third data string includes normalizing-coefficient information.

29. An information processing method according to claim 27, wherein the second data string is a coded data string, and the first data contained in the third data string includes quantizing-precision information.

30. An information processing method according to claim 21, further comprising:
a decoding step of decoding input data so as to transform the input data into frequency components; and
an inverse transform step of inverse-transforming the frequency components transformed in said decoding step into signal components, wherein
the first data contained in the third data string includes spectrum-coefficient information of the frequency components.

31. An information processing method according to claim 21, wherein the second data is data in which at least part of the first data is replaced by random data.

32. An information processing method according to claim 21, further comprising a transmission control step of controlling a signal indicating a request for the third data string to be transmitted to said first information processing apparatus by designating the playback quality or the recording quality of the fourth data string generated in said generating step.

33. An information processing apparatus for generating a fourth data string by using a second data string generated from a first data string and by using a third data string received from a first information processing apparatus, said information processing apparatus comprising:
reception means for receiving the third data string from said first information processing apparatus;
replacement means for replacing first data contained in the third data string received by said reception means by second data contained in the second data string; and
generating means for generating the fourth data string to be played back or recorded in at least one zone by using data generated by said replacement means.

34. A recording medium recording therein a computer-readable program for an information processing apparatus that generates a fourth data string by using a second data string generated from a first data string and by using a third data string received from a first information processing apparatus, said computer-readable program comprising:
a reception control step of controlling the third data string to be received from said first information processing apparatus;
a replacement step of replacing first data contained in the third data string controlled to be received in said reception control step by second data contained in the second data string; and
a generating step of generating the fourth data string to be played back or recorded in at least one zone by using data generated in said replacement step.

35. A computer-executable program for controlling an information processing apparatus that generates a fourth data string by using a second data string generated from a first data string and by using a third data string received from a first information processing apparatus, said computer-executable program comprising:
a reception control step of controlling the third data string to be received from said first information processing apparatus;
a replacement step of replacing first data contained in the third data string controlled to be received in said reception control step by second data contained in the second data string; and
a generating step of generating the fourth data string to be played back or recorded in at least one zone by using data generated in said replacement step.
